(19) United States
(12) Patent Application Publication
(10) Pub. No.: US 2026/0143075 A1
(43) Pub. Date: May 21, 2026

(54) SYSTEM AND IMAGE FORMING DEVICE

(71) Applicant: BROTHER KOGYO KABUSHIKI KAISHA, Nagoya (JP)

(72) Inventor: Yutaka URAKAWA, Nagoya (JP)

(73) Assignee: BROTHER KOGYO KABUSHIKI KAISHA, Nagoya (JP)

(21) Appl. No.: 19/366,774

(22) Filed: Oct. 23, 2025

(30) Foreign Application Priority Data
Nov. 15, 2024 (JP) 2024-199747

(51) Int. Cl. H04N 1/00; G06F 3/14

(52) U.S. Cl. CPC H04N 1/00973; H04N 1/00209; H04N 1/00384; H04N 1/00411; H04N 1/0048; H04N 1/00503; G06F 3/1454; H04N 2201/0075; H04N 2201/0094

(57) ABSTRACT

A system includes an image forming device, a first information processing device, and a second information processing device. The first information processing device, the second information processing device, and the image forming device are connected to the Internet. The image forming device includes a display, and the image forming device is configured to cause the display to display a main body operation screen including a plurality of operators. The image forming device is configured to execute an image upload process of uploading, to the cloud storage, first image data indicating a first remote operation screen, the first remote operation screen being a screen for virtually reproducing the main body operation screen displayed on the display.

### REFERENCE TO RELATED APPLICATIONS

This application claims priority from Japanese Patent Application No. 2024-199747 filed on November 15, 2024. The entire content of the priority application is incorporated herein by reference.

### BACKGROUND ART

There is a technique for an image forming device capable of performing image formation such as printing and scanning, in which various input operations are received via an operation panel. For example, a related art discloses a function execution device including a printing unit, an image reading unit, and an operation panel, in which the operation panel includes a hardware key and a touch panel, and an input operation on the hardware key or an input operation to an icon or button displayed on the touch panel is received.

In recent years, there has been an increasing demand for so-called remote operation of an image forming device, which enables an information processing device to perform an input operation on an operation panel of the image forming device without touching the operation panel. The related art does not disclose a technique for controlling an image forming device by a remote operation, and there is room for improvement.

### SUMMARY

A system including an image forming device, a first information processing device, and a second information processing device. The first information processing device, the second information processing device, and the image forming device are connected to the Internet. The image forming device includes a display, and the image forming device is configured to cause the display to display a main body operation screen including a plurality of operators. The image forming device is configured to execute an image upload process of uploading, to the cloud storage, first image data indicating a first remote operation screen, the first remote operation screen being a screen for virtually reproducing the main body operation screen displayed on the display. The first information processing device is configured to execute a screen display process of downloading the first image data from the cloud storage to cause a user interface of the first information processing device to display the first remote operation screen indicated by the first image data. The first information processing device is configured to execute an operation upload process of uploading, to the cloud storage, first operation data indicating an operation content, in a case where an operation on the first remote operation screen is received via the user interface of the first information processing device. The image forming device is configured to download the first operation data from the cloud storage to execute a process corresponding to an operation indicated by the first operation data. The image forming device is configured to execute an image transmission process of transmitting, to the second information processing device, second image data indicating a second remote operation screen, not via the cloud storage, the second remote operation screen being a screen for virtually reproducing the main body operation screen displayed on the display. The second information processing device is configured to execute a local screen display process of causing a user interface of the second information processing device to display the second remote operation screen indicated by the received second image data. The second information processing device is configured to execute an operation transmission process of transmitting, to the image forming device, second operation data indicating an operation content, not via the cloud storage, in a case where an operation on the second remote operation screen is received via the user interface of the second information processing device. The image forming device is configured to execute a process corresponding to an operation indicated by the received second operation data, in a case where the image forming device receives the second operation data from the second information processing device. In a case where the image forming device starts the provision of the first remote operation after receiving the start instruction of the first remote operation, the image forming device is configured to enter a first remote operation providing state until an ending condition of the first remote operation is satisfied. In a case where the image forming device enters the first remote operation providing state, the image forming device is configured not to cause the display to display the main body operation screen. In a case where the image forming device does not enter the first remote operation providing state, the image forming device is configured to cause the display to display the main body operation screen.

### BRIEF DESCRIPTION OF DRAWINGS

FIG. 1 is a diagram illustrating an outline of a remote operation system according to the present embodiment.

FIG. 2 is a diagram illustrating an outline of the remote operation system according to the present embodiment.

FIG. 3 is a diagram illustrating an outline of the remote operation system according to the present embodiment.

FIG. 4 is a sequence diagram illustrating an example of a start instruction procedure.

FIG. 5A is a diagram illustrating an example of a data structure.

FIG. 5B is a diagram illustrating an example of the data structure.

FIG. 5C is a diagram illustrating an example of the data structure.

FIG. 5D is a diagram illustrating an example of the data structure.

FIG. 6 is a flowchart illustrating an example of a procedure of a start determination process.

FIG. 7 is a diagram illustrating an example of a use permission confirmation screen.

FIG. 8 is a sequence diagram illustrating an example of a screen preparation procedure.

FIG. 9 is a diagram illustrating an example of an execution file.

FIG. 10 is a flowchart illustrating an example of a procedure of an image storage process.

FIG. 11 is a diagram illustrating an example of a provision-in-progress screen.

FIG. 12 is a diagram illustrating an example of information stored in a structured storage.

FIG. 13 is a diagram illustrating an example of a state where a screen is synchronized.

FIG. 14 is a sequence diagram illustrating an example of a remote operation procedure.

FIG. 15 is a flowchart illustrating an example of a procedure of a browser image changing process.

FIG. 16 is a flowchart illustrating an example of a procedure of a device image changing process.

FIG. 17 is a flowchart illustrating an example of a procedure of an operation information process.

FIG. 18 is a sequence diagram illustrating an example of an operation ending procedure.

FIG. 19 is a sequence diagram illustrating an example of a local operation procedure.

FIG. 20 is a diagram illustrating an example of an HTML file.

FIG. 21 is a flowchart illustrating an example of a procedure of a secondary remote process.

FIG. 22 is a diagram illustrating an example of a screen displayed on each device.

FIG. 23 is a diagram illustrating an example of a screen displayed on each device in each mode.

### DESCRIPTION

Hereinafter, an embodiment embodying a system will be described in detail with reference to the accompanying drawings. The present specification discloses a remote operation system in which a multi function device (hereinafter referred to as "MFP") having an image forming function and a communication function can be operated using a personal computer (hereinafter referred to as "PC").

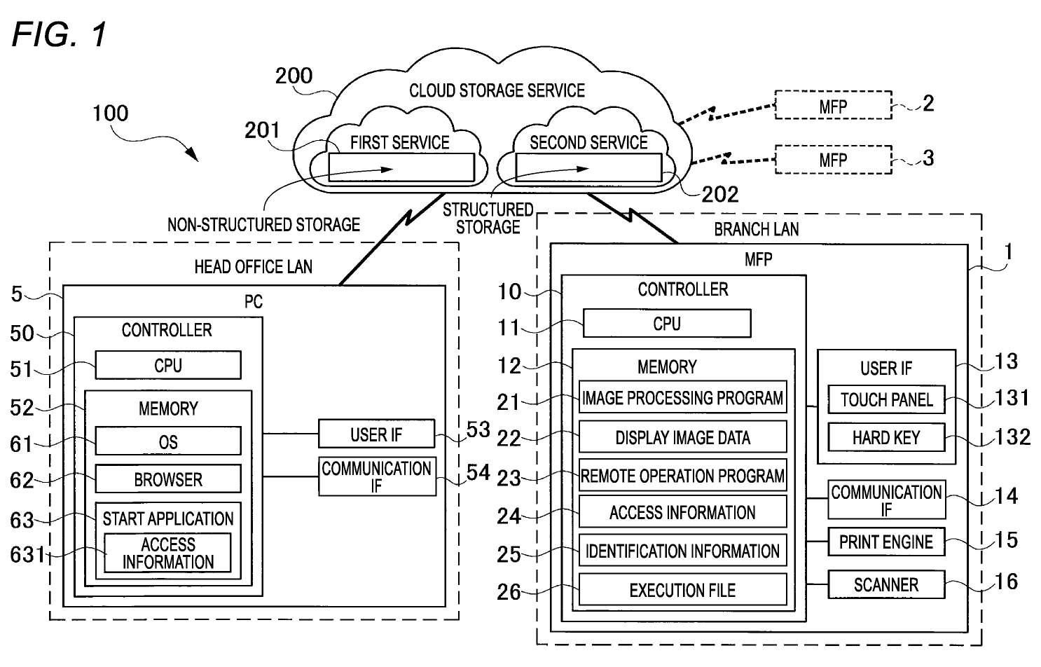

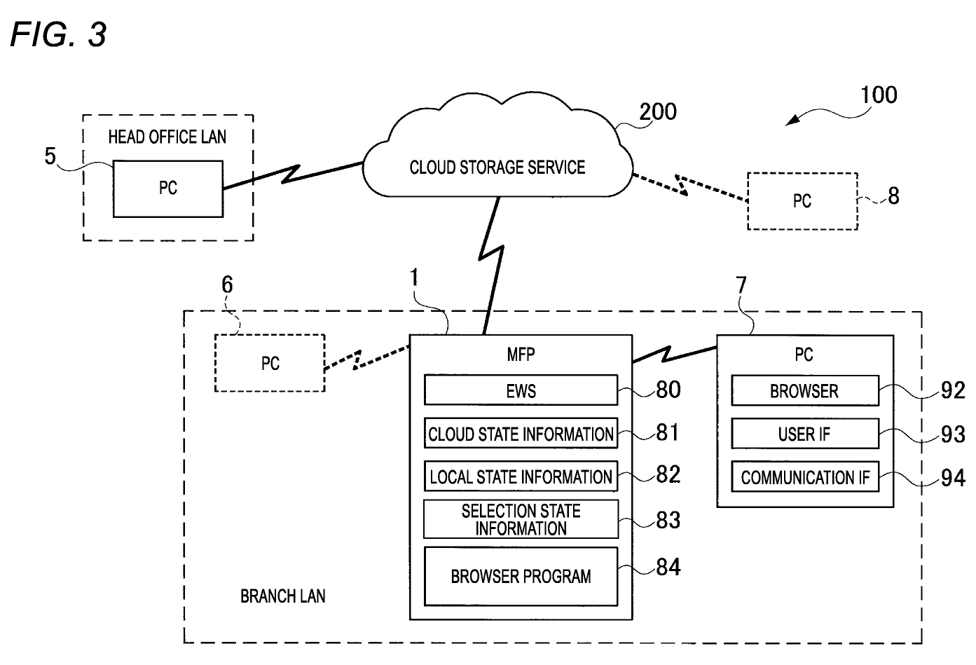

For example, as illustrated in FIGS. 1 to 3, a remote operation system 100 according to the present embodiment includes an MFP 1 to be remotely operated, and a PC 5 (see FIG. 1) and a PC 7 (see FIG. 3) used by each user who remotely operates the MFP 1. The PC 5 is disposed, for example, in a head office, a system management company, or a management organization that manages an operational organization, and the MFP 1 and PC 7 are disposed, for example, in a branch office, a client company, and an operational organization that operates the MFP 1. The remote operation system 100 is an example of a system.

Both the MFP 1 and the PC 5 are connected to the Internet, and is configured to use the cloud storage service 200 via the Internet. The cloud storage service 200 is a service that has a communication function via an Internet line and is configured to store various kinds of information. The MFP 1 and the PC 7 can perform local communication by local connection. The MFP 1 is an example of an image forming device, the PC 5 is an example of a first information processing device, and the PC 7 is an example of a second information processing device. The remote operation system 100 may further include other MFPs 2 and 3 and other PCs 6 and 8.

The MFP 1 of the remote operation system 100 according to the present embodiment can receive, via the cloud storage service 200, a remote operation from the PC 5 or the like connectable to the Internet. The MFP 1 can also receive a remote operation not via the cloud storage service 200 from the locally connected PC 7 or the like. Hereinafter, a remote operation via the cloud storage service 200 is referred to as a "cloud remote operation". In addition, a remote operation according to the local communication not via the cloud storage service 200 is referred to as a "local remote operation". The cloud remote operation is an example of a first remote operation, and the local remote operation is an example of a second remote operation.

As illustrated in FIG. 1, the MFP 1 to be operated by the remote operation system 100 includes a controller 10 including a CPU 11 and a memory 12, for example. The MFP 1 includes a user interface (hereinafter, referred to as a "user IF") 13, a communication interface (hereinafter, referred to as a "communication IF") 14, a print engine 15, and a scanner 16 that are electrically connected to the controller 10.

The CPU 11 of the MFP 1 executes various types of processes, in accordance with a program read from the memory 12 and based on a user operation. The memory 12 of the MFP 1 can store various programs and data including an image processing program 21, display image data 22, a remote operation program 23, access information 24, identification information 25, and an execution file 26. The memory 12 is used as a work area in a case where various types of processes are executed. A buffer provided in the CPU 11 is also an example of the memory 12.

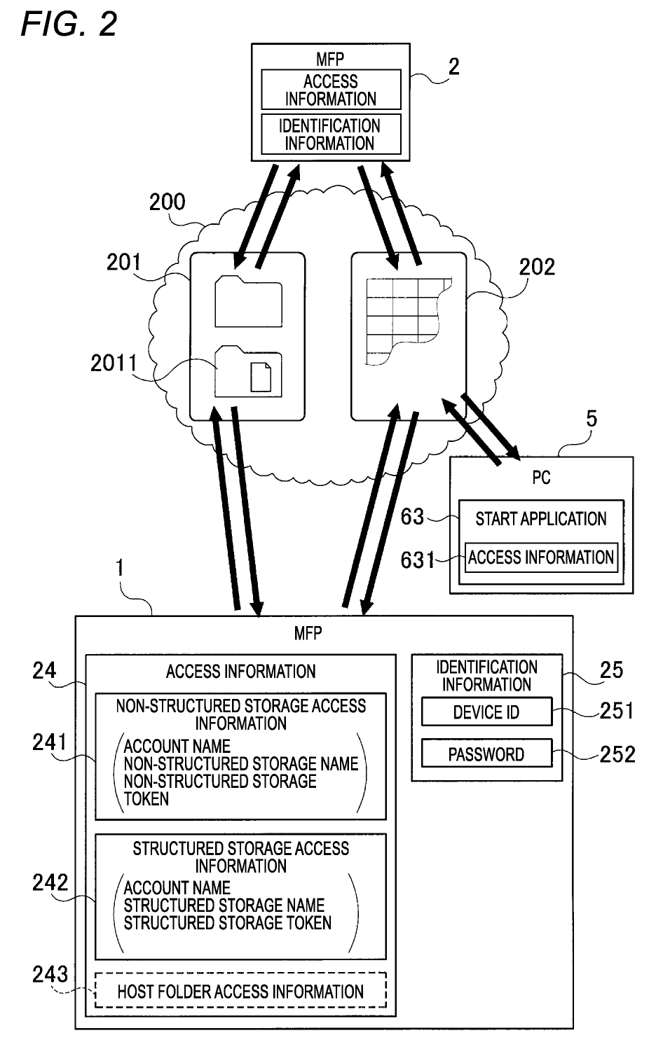

The image processing program 21 is a program for causing the MFP 1 to execute various types of image processes. The display image data 22 is a data group indicating images used as components of various screens displayed on the user IF 13 of the MFP 1. The identification information 25 is unique information for identifying the MFP 1. The identification information 25 may include, for example, a device ID 251 and a password 252 as illustrated in FIG. 2.

The remote operation program 23, the access information 24, and the execution file 26 are information for the MFP 1 to receive a cloud remote operation. The remote operation program 23 is a program for receiving a cloud remote operation. The access information 24 is information for accessing the cloud storage service 200. The execution file 26 is a data file including a program for causing the PC 5 or the like to perform a cloud remote operation. The program and data will be described later in detail.

The access information 24 is not stored in the memory 12 at the time of factory shipment of the MFP 1. The remote operation program 23 and the execution file 26 may not be stored in the memory 12 at the time of factory shipment of the MFP 1.

An example of the memory 12 is not limited to a ROM, a RAM, an HDD, and the like incorporated into the MFP 1, and may be a storage medium readable and writable by the CPU 11. The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal conveying a program downloaded from a server or the like on the Internet is a computer-readable signal medium, which is a kind of computer-readable medium, but is not included in the non-transitory computer-readable storage medium.

The user IF 13 includes hardware configured to display a screen for notifying a user of information, and hardware configured to receive an operation from the user. The user IF 13 of the MFP 1 includes a touch panel 131 having a screen display function and an operation receiving function, and a plurality of hardware keys (hereinafter referred to as "hard keys") 132. The user IF 13 is an example of an operation panel, and the touch panel 131 is also an example of a display.

The communication IF 14 includes hardware for communicating with an external device. The communication IF 14 has functions compatible with communication standards such as Wi-Fi (registered trademark), Ethernet (registered trademark), and USB. The communication IF 14 can communicate with a server on the Internet using an HTTPS protocol.

The print engine 15 has a configuration configured to print an image based on image data on a print medium such as a sheet. A printing method of the print engine 15 is, for example, an electrophotographic method or an ink-jet method. The scanner 16 includes a configuration configured to read an image of a document and acquire image data.

The PC 5 for executing the cloud remote operation includes, for example, a controller 50 including an CPU 51 and a memory 52 as illustrated in FIG. 1. The PC 5 includes a user IF 53 and a communication IF 54 that are electrically connected to the controller 50. The user IF 53 includes hardware configured to display a screen for notifying a user of information, and hardware configured to receive an operation from the user. The user IF 53 may or may not have a touch panel. The communication IF 54 has a function of being connectable to the Internet using an HTTPS protocol.

The memory 52 of the PC 5 can store various programs and data including an operating system (hereinafter referred to as an "OS") 61, a browser 62, and an application program (hereinafter referred to as a "start application") 63 for supporting the start of a remote operation. The program and data will be described later in detail.

The cloud storage service 200 is, for example, a service that is operated by a company using the MFP 1 or a third party other than a vendor of the MFP 1, and includes a storage group accessible via the Internet. The cloud storage service 200 includes a first service having a non-structured storage area in which various data such as files including binary data can be placed, and a second service having an area in which structured text data can be stored.

The cloud storage service 200 may be, for example, an Azure (registered trademark) storage service provided by Microsoft (registered trademark), the first service may be a BLOB storage service, and the second service may be a Table storage service. The cloud storage service 200 may be, for example, Google (registered trademark) Cloud or Amazon (registered trademark) AWS (registered trademark). The cloud storage service 200 may be, for example, a service operated by a vendor of the image forming device.

The cloud storage service 200 also has a Web server function in addition to a storage function as a data storage place. For example, the first service and the second service of the cloud storage service 200 behave as a Web server when an HTTPS access is received, and can return a response that can be displayed by a browser.

For example, a system administrator of a company or the like that uses the remote operation system 100 according to the present embodiment prepares for using a remote operation via the cloud storage service 200. Specifically, the system administrator makes a contract with a company that operates the cloud storage service 200, and acquires an account name for using the cloud storage service 200. The account name may be common to all companies, or may be different for each country, each region, each business department, or the like.

Further, the system administrator provides a storage area corresponding to an account indicated by the acquired account name in the cloud storage service 200 for each of the first service and the second service, and acquires a token for each service. Hereinafter, in the cloud storage service 200, a storage area corresponding to an account used in the remote operation system 100 and provided for the first service is referred to as a non-structured storage 201, and a storage area provided for the second service is referred to as a structured storage 202. The non-structured storage 201 and the structured storage 202 are examples of cloud storage. The configuration and stored information of each storage will be described later.

The system administrator sets anonymous access prohibition to at least the non-structured storage 201. The area set to be anonymous access prohibition is configured to receive only an access request based on a URL to which a correct token is added as a query, and configured not to receive an access in a case where the query is not added or the added query is not correct. In addition, even in a case where link information to another file is included in the file written in the area set to the anonymous access prohibition, the link access using the link information is prohibited. Each token is, for example, a shared access signature (SAS) token.

Further, as illustrated in FIG. 2, the system administrator causes each MFP to be operated by the remote operation system 100 to store the access information 24 including non-structured storage access information 241, which is access information for accessing the non-structured storage 201, and structured storage access information 242, which is access information for accessing the structured storage 202. The system administrator stores the access information 24 in a non-volatile area of the memory of each MFP.

For example, as illustrated in FIG. 2, the non-structured storage access information 241 includes an account name which is a text indicating an account acquired by the system administrator, a non-structured storage name which is a text indicating the non-structured storage 201, and a non-structured storage token which is an SAS token for accessing the non-structured storage 201. That is, the URL for accessing the non-structured storage 201 includes a text in which each piece of information illustrated in FIG. 2 is combined according to a predetermined rule. The non-structured storage access information 241 may be information described in the format of a URL, or may be information including each piece of information and its combination rule.

For example, the structured storage access information 242 includes an account name which is a text indicating an account acquired by the system administrator, a structured storage name which is a text indicating the structured storage 202, and a structured storage token which is an SAS token for accessing the structured storage 202. The URL for accessing the structured storage 202 includes a text in which each piece of information illustrated in FIG. 2 is combined according to a predetermined rule. The structured storage access information 242 may be information described in the format of a URL, or may be information including each piece of information and its combination rule.

Each MFP may acquire the token. For example, the system administrator may store the account name in each MFP, and the MFP may access the cloud storage service 200 using the account name to acquire each token. In this case, each MFP includes the acquired token in the access information 24 and stores the token in the non-volatile area of the memory.

The MFP 1 can create the non-structured storage access information 241 and the structured storage access information 242, based on the stored information. For example, the system administrator may store the account name in the MFP 1, and the MFP 1 may combine the account name and the token to create the non-structured storage access information 241 and the structured storage access information 242. In this case, the token may be acquired by each MFP or may be stored in each MFP by the system administrator.

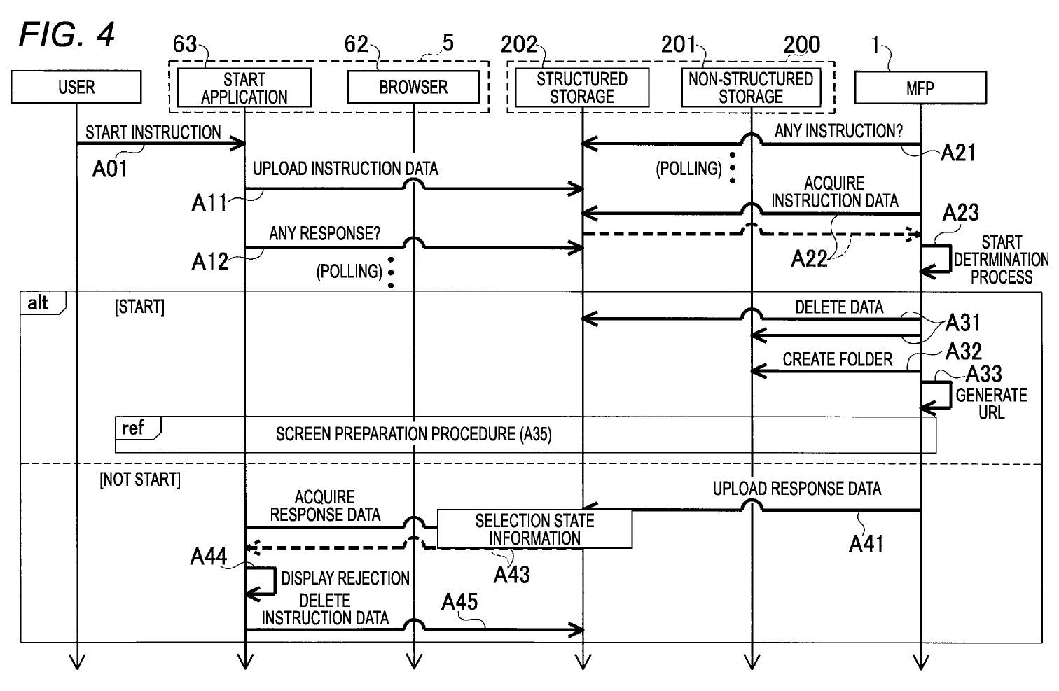

Although details will be described later, each MFP is configured to create, for example, a folder whose folder name includes its own device ID in the non-structured storage 201 when using the remote operation system 100. For example, the MFP 1 is configured to create a folder 2011 using the device ID 251 illustrated in FIG. 2 in A32 of FIG. 4 to be described later. Further, the MFP 1 combines the non-structured storage access information 241 stored in the memory with its own device ID 251 to create access information for non-anonymous access to the folder 2011 created in the non-structured storage 201 (for example, A33 in FIG. 4). This access information is referred to as host folder access information 243 for convenience, as illustrated in FIG. 2. The system administrator may create a folder for each MFP in the non-structured storage 201 in advance and store access information for accessing the folder in each MFP.

Since a data storage area is created for each MFP such as a folder whose folder name includes a device ID, even if HTTPS requests that specify different MFPs are simultaneously generated from different browsers, the non-structured storage 201 can return appropriate responses based on data stored in the folder for the MFPs corresponding to requests. That is, as will be described in detail later, using the cloud storage service 200, it is possible to perform cloud remote operations for different MFPs from different PCs.

As illustrated in FIG. 1, the system administrator stores access information 631 for accessing the structured storage 202 in a start application 63 installed in the PC 5. The access information 631 is information used for the start application 63 to access an area accessible by the MFP 1 using the structured storage access information 242 in the structured storage 202. The access information 631 may be the same as or partially different from the structured storage access information 242 used by the MFP 1. The start application 63 of the PC that performs a cloud remote operation can perform a cloud remote operation for only each MFP that uses the structured storage 202 accessible by the PC.

For the access information 631, instead of storing the URL in the start application 63, an account name, a token, or the like may be stored, and the start application 63 may create the URL. The start application 63 may acquire the token using the account name stored in the PC and create the access information 631 using the acquired token. Specifically, the access information 631 is in the form of a URI.

On the other hand, the MFP 1 and the PC 7 are connected to the same branch LAN, for example, and is configured to communicate with each other by local communication. The local communication includes, for example, wired communication such as local wireless communication, local LAN communication, and USB communication. For example, as illustrated in FIG. 3, the MFP 1 includes a program and data (hereinafter referred to as "EWS") 80 for realizing an embedded web server function. The MFP 1 is configured to receive access to the EWS 80 through local communication. A user who uses the PC 7 can remotely operate the MFP 1 by local communication not via the cloud storage service 200.

The local wireless communication may be, for example, communication in a form in which the MFP 1 and a PC or the like perform wireless communication directly or may be communication in a form in which the MFP 1 and a PC or the like perform wireless connection without using the Internet. The form in which the MFP 1 and the PC or the like perform wireless connection without using the Internet may be, for example, a form in which the MFP 1 and the PC or the like are wirelessly connected to one access point and communicate with each other via the access point, for example, a form in which the MFP 1 and the PC communicate with each other using a protocol of a wireless LAN. In addition, the local LAN communication may be communication, for example, wired LAN communication in a form in which the MFP 1 is connected to a PC or the like via a LAN cable or a LAN cable and a hub, without using the Internet. The USB communication may be communication in a form in which the MFP 1 is connected to a PC or the like via a USB cable or a USB cable and a hub.

For example, as illustrated in FIG. 3, the MFP 1 further stores cloud state information 81, local state information 82, selection state information 83, and a browser program 84 in the memory 12 (see FIG. 1). Each of the cloud state information 81, the local state information 82, and the selection state information 83 is information indicating the state of the MFP 1, and is information indicating which of a plurality of states is. The browser program 84 is a program for receiving a local remote operation. The browser program 84 is an example of a second remote operation program. The information will be described later in detail.

The PC 7 for performing the local remote operation includes, for example, a user IF 93 and a communication IF 94 as illustrated in FIG. 3. Further, a browser 92 is installed in the PC 7. The PC 7 may or may not be connected to the Internet. The PC 7 can access the EWS 80 of the MFP 1 through local communication.

Next, a procedure for remotely operating the MFP 1 will be described. The following processes basically represent processes of the CPU according to commands written in programs. That is, the processes such as "judgment", "extraction", "selection", "calculation", "determination", "specification", "acquisition", "reception", and "control" to be described below represent the processes of the CPU. The processes by the CPU also include hardware control using API of the OS. In the present specification, the description of the OS is omitted, and an operation of each program is described. That is, in the following description, the description that "a program B controls hardware C" may refer to "the program B controls the hardware C, using the API of the OS". In addition, the processes of the CPU according to the commands written in the programs may be described in omitted words. For example, the processes of the CPU may be described as "the CPU performs". In addition, the processes of the CPU according to the commands written in the programs may be described in words in which the CPU is omitted, such as "the program A performs".

In addition, in the present specification, "notification", "alert", "notifying", "reply", "response", "answer", and the like are not limited to a meaning of transmission of information to a person, and are also used as words meaning communication or exchange of information between devices or between components in a device. The configuration in the device includes software.

The term "acquisition" is used as a concept indicating that a request is not essential. That is, a process of receiving data without a request from the CPU is also included in a concept indicating that "the CPU acquires data". In addition, the term "data" in the present specification is represented by a computer-readable bit string. Furthermore, data having substantially the same meaning and different formats are treated as the same data. The same applies to "information" in the present specification. In addition, the term "request" or "instruct" is a concept indicating that information indicating that a request is being made or information indicating that an instruction is being given is output to a partner. In addition, the information indicating that a request is being made or the information indicating that an instruction is being given is simply referred to as a "request" or "instruction".

According to the CPU, a process of determining whether information A indicates that it is a matter B may be conceptually described as "determining whether it is the matter B, based on the information A". According to the CPU, a process of determining whether the information A indicates that it is the matter B or a matter C may be conceptually described as "determining whether it is the matter B or the matter C, based on the information A".

In the present specification, a setting item may be simply referred to as "setting". A setting value may be simply referred to as "setting". The setting value may be described as a "parameter". Furthermore, storing the setting value in a memory or the like may be simply referred to as "setting". An operation for setting or input for setting may be simply referred to as "setting".

A start instruction procedure for starting a cloud remote operation of the MFP 1 by the remote operation system 100 using the PC 5 will be described with reference to a sequence diagram of FIG. 4. A user who wants to perform a cloud remote operation, for example, a system administrator activates the start application 63 in the PC 5, specifies the MFP 1 which is a device to be operated, and performs an operation of instructing the start of the cloud remote operation (A01). In the start application 63, each device ID of each MFP that may be subjected to the cloud remote operation is registered in advance. In A01, the start application 63 can specify the device ID of the device to be operated, based on the user operation.

The start of the cloud remote operation requires a password included in identification information of the device to be operated. The user also performs an operation of inputting a password of the MFP 1 in A01. By executing the authentication using the password, it is possible to improve the safety of the cloud remote operation.

The start application 63 uploads instruction data, which is information indicating the input start instruction, to the structured storage 202 (A11). As described above, the start application 63 includes the access information 631 for accessing the structured storage 202, and can execute the upload by accessing the structured storage 202 using the access information 631. Thereafter, even if there is no particular description, the start application 63 accesses the structured storage 202 using the access information 631.

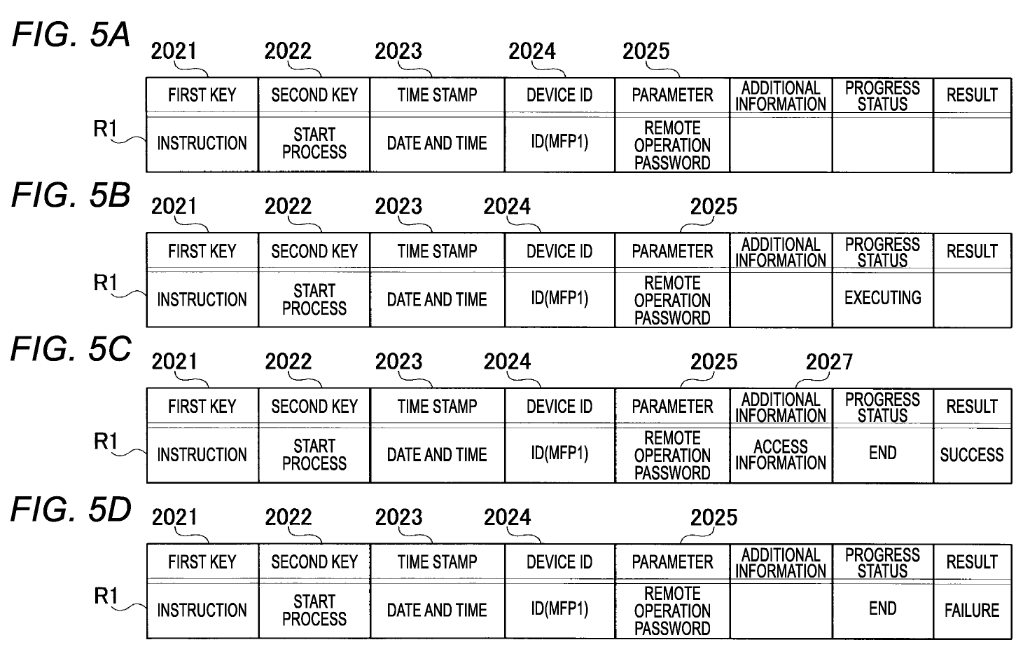

The structured storage 202 is configured to store a structured database having a structure including a plurality of records. Each record includes, for example, as illustrated in FIGS. 5A to 5D, a first key 2021, a second key 2022, a time stamp 2023, a device ID 2024, and a parameter 2025. The system administrator registers information indicating a structure of the structured database including a structure of each record in the structured storage 202, and the structured storage 202 can store the structured database. The start application 63 may register information indicating the structure of the structured database in the structured storage 202.

The first key 2021 and the second key 2022 are information indicating the type of the content of the record. For example, in A11, as illustrated in FIG. 5A, the start application 63 uploads each piece of information to the structured storage 202 so that each piece of information is stored in a record R1. Uploading information may be referred to as uploading data. In addition, uploading information such that each record stores information may be described as uploading a record, for convenience. Uploading information may be referred to as uploading data.

When each device such as the PC 5 or the MFP 1 uploads each piece of information by specifying the first key 2021 and the second key 2022, the structured storage 202 stores the uploaded information in the record in which the information specified in both the first key 2021 and the second key 2022 is stored. When each device specifies the first key 2021 and the second key 2022 and requests the download of the information stored in the corresponding record, the structured storage 202 transmits, to a request source, information stored in the record in which both the first key 2021 and the second key 2022 specified by the request are stored. That is, the first key 2021 and the second key 2022 are also information for specifying a record.

That is, in A11, the start application 63 uploads the information to the structured storage 202 to become the record R1 illustrated in FIG. 5A. As a result, the first key 2021 of the record R1 stores information indicating that the record is a record storing information categorized as an instruction, and the second key 2022 stores information indicating an instruction of a start process among the information categorized as an instruction. The device ID 2024 of the record R1 stores the device ID indicating the MFP 1. Accordingly, the record R1 is a record indicating instruction data addressed to the MFP 1.

The time stamp 2023 is information indicating a date and time when data is stored in the record. The device ID 2024 is information for specifying a device which is a target of the data stored in the record, and the device ID of the device to be subjected to the cloud remote operation is stored in the record R1. The parameter 2025 includes various kinds of information necessary for cloud remote operation. Each record included in the data structure further includes additional information as necessary. For example, in the instruction data uploaded in A11, as illustrated in FIG. 5A, information indicating that the process to be started is a cloud remote operation and a password input in A01 are stored in the parameter 2025.

On the other hand, each MFP that may be subjected to the cloud remote operation periodically accesses the structured storage 202 using the structured storage access information stored in each memory, and monitors a record in which its own device ID 251 (see FIG. 2) is stored in the device ID 2024, thereby confirming whether there is an instruction to be processed by the MFP itself (A21). For example, the MFP 1 periodically accesses the structured storage 202 using the structured storage access information 242 (see FIG. 2). Thereafter, even if there is no particular description, the MFP 1 accesses the structured storage 202 using the structured storage access information 242.

When the record R1 illustrated in FIG. 5A is uploaded in A11, the MFP 1 can download the stored data from the record R1 of the structured storage 202 (A22). As the MFP 1 acquires instruction data indicating an instruction to the MFP 1 from the record R1, the MFP 1 starts a process based on the received instruction. When the instruction data downloaded in A22 is an instruction data indicating a start instruction of the cloud remote operation, A22 is an example of the start instruction of the first remote operation.

As illustrated in FIG. 5B, the MFP 1 uploads information indicating the progress status of "executing" to the structured storage 202 such that the information is stored in the record R1. Further, since an instruction according to the record R1 is a start instruction of the cloud remote operation, the MFP 1 executes a start determination process of determining whether to permit the start of the cloud remote operation (A23).

On the other hand, after executing the upload of the instruction data indicating the start instruction of the cloud remote operation in A11, the start application 63 of the PC 5 periodically accesses the record R1 of the structured storage 202 and monitors whether the information indicating the response is stored in the record R1 (A12). For example, the start application 63 may stop the cloud remote operation in a case where information indicating "executing" or "ending" is not stored even when a predetermined time elapses after the upload of the record R1. The "ending" is uploaded by the MFP 1 to be stored in the record R1 when the process based on the instruction received by the MFP 1 is ended.

The MFP 1 is configured to receive a start request for the cloud remote operation by periodically monitoring the structured storage 202, and is configured to receive a start request for the local remote operation from the PC 7 or the like capable of local communication via the communication IF 14. For example, when the MFP 1 receives an access to the EWS 80 by specifying access information indicating the start request for the local remote operation, the MFP 1 determines that the start request for the local remote operation is received. The access to the EWS 80 is an example of a start instruction of the second remote operation. The MFP 1 can receive, for example, both a start request for a cloud remote operation by the PC 5 and a start request for a local remote operation by the PC 7.

For example, the user of the PC 7 illustrated in FIG. 3 can activate the browser 92 on the PC 7 and specify access information indicating the local remote operation of the MFP 1 to cause the PC 7 to access the EWS 80 of the MFP 1 and transmit the start request for the local remote operation. The user of the PC 7 may transmit the start request for the local remote operation to the PC 7 via a Web page based on Web page data returned from the EWS 80.

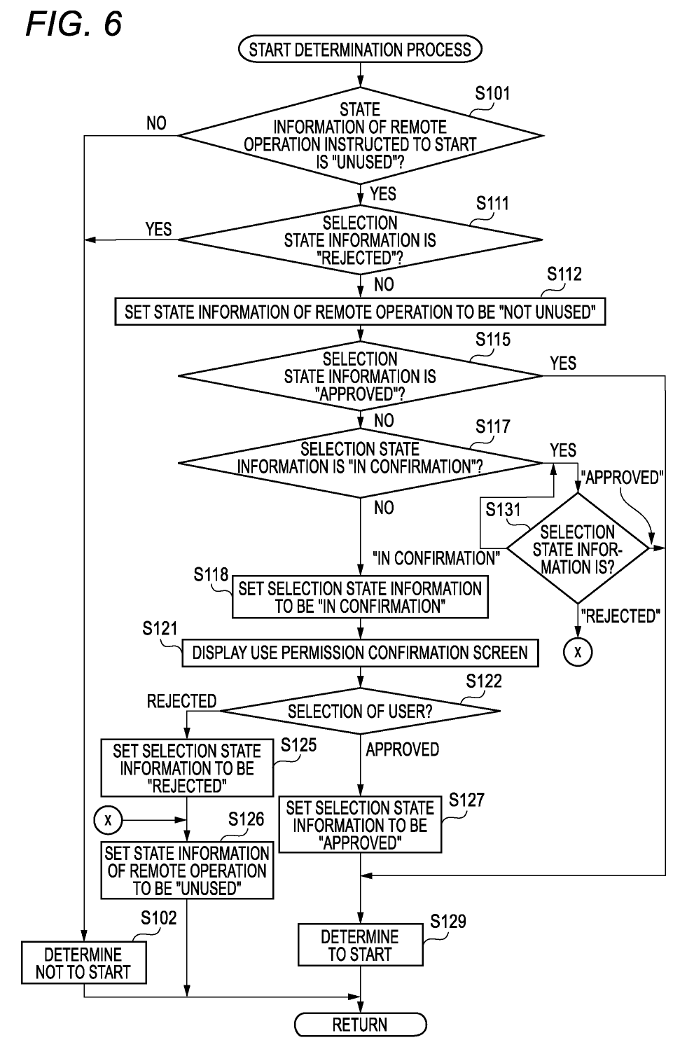

The MFP 1 is configured to receive both the start request for the cloud remote operation by the PC 5 and the like and the start request for the local remote operation by the PC 7 and the like. When the start request for the cloud remote operation is received, the MFP 1 executes the start determination process in A23. As will be described later, the MFP 1 also executes the start determination process in the same manner when receiving the start request for the local remote operation. The start determination process is a process of determining whether to start the remote operation in response to the received start request. The procedure of the start determination process will be described with reference to the flowchart in FIG. 6.

In the start determination process, as illustrated in FIG. 3, the CPU 11 determines whether the state information of the remote operation instructed to start in response to the start request is information indicating "unused" among the cloud state information 81 and the local state information 82 stored in the memory 12 (S101). When the execution of the start determination process is started by receiving the start request for the cloud remote operation from the PC 5 or the like, the CPU 11 confirms the cloud state information 81. When the execution of the start determination process is started by receiving the start request for the local remote operation from the PC 7 or the like, the CPU 11 confirms the local state information 82.

The cloud state information 81 and the local state information 82 are information indicating either "unused" or "not unused". Here, "unused" is information indicating a state where a cloud remote operation or a local remote operation is not provided, that is, a state where a start request is not received. Here, "not unused" is information indicating a state other than "unused", and is information indicating a state where each remote operation is being provided or a state where a start request is received and it is determined whether to provide a remote operation.

If it is determined that the state information to be confirmed indicates "not unused" (S101: NO), the CPU 11 determines not to start providing the requested remote operation (S102), and ends the start determination process. The MFP 1 according to the present embodiment does not start a new cloud remote operation if the cloud remote operation is being provided or the start request for the cloud remote operation has been received. Further, the MFP 1 according to the present embodiment does not start a new local remote operation if the local remote operation is being provided or the start request for the local remote operation has been received.

If it is determined that the state information to be confirmed is "unused" (S101: YES), the CPU 11 determines whether the selection state information 83 stored in the memory 12 is information indicating "rejected" as illustrated in FIG. 3 (S111). The selection state information 83 is information indicating any one of "approved", "in confirmation", or "rejected". The "rejected" is information indicating a state where the remote operation is rejected by the user of the MFP 1 through a use permission confirmation screen 71 to be described later. Here, "in confirmation" is information indicating a state where the use permission confirmation screen 71 is displayed and the user input is waiting. The "approved" is information indicating a state where the remote operation is approved by the user of the MFP 1 through the use permission confirmation screen 71. When none of the states is satisfied, the selection state information 83 does not indicate any one of "approved", "in confirmation", or "rejected". In this case, for example, the selection state information 83 may be information indicating "before confirmation" or information indicating "initial".

If it is determined that the selection state information 83 is "rejected" (S111: YES), the CPU 11 determines not to start the requested cloud remote operation (S102), and ends the start determination process. In a state where the remote operation is rejected by the user of the MFP 1, the MFP 1 receives neither the cloud remote operation nor the local remote operation. The determination in S101 and the determination in S111 may be reversed.

If it is determined that the selection state information 83 is not information indicating "rejected" (S111: NO), the CPU 11 changes the state information of the remote operation that has received the start instruction to "not unused" (S112). When the start request for the cloud remote operation is received, the CPU 11 changes the cloud state information 81 to "not unused". When the start request for the local remote operation is received, the CPU 11 changes the local state information 82 to "not unused".

The CPU 11 determines whether the selection state information 83 is information indicating "approved" (S115). If it is determined that the selection state information 83 is not information indicating "approved" (S115: NO), the CPU 11 determines whether the selection state information 83 is information indicating "in confirmation" (S117). If it is determined that the selection state information 83 is not information indicating "in confirmation" (S117: NO), that is, when the selection state information 83 does not indicate any of "approved", "in confirmation", and "rejected", the CPU 11 sets the selection state information 83 to information indicating "in confirmation" (S118).

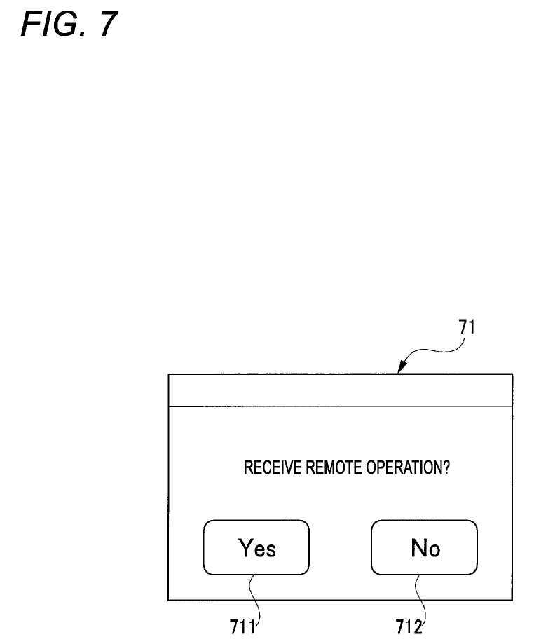

The CPU 11 displays a use permission confirmation screen on the touch panel 131 of the user IF 13 (S121). For example, as illustrated in FIG. 7, the CPU 11 causes the touch panel 131 to display the use permission confirmation screen 71 including a message inquiring whether to approve the reception of the remote operation, a "Yes" button 711 indicating that the remote operation is approved, and a "No" button 712 indicating the rejection of the remote operation, and receives an input indicating a selection operation of the user.

The CPU 11 waits until the user input is received, and when the user input is received, the CPU 11 determines whether the received button is the "Yes" button 711 or the "No" button 712 (S122). In a case where it is determined that the selection result of the user is rejected (S122: rejected), the CPU 11 sets the selection state information 83 to be "rejected" (S125). Further, the CPU 11 changes, to "unused", the state information 81 or 82 that has been changed to "not unused" in S112 (S126). Further, the CPU 11 returns the display of the touch panel 131 to a state before the use permission confirmation screen 71 is displayed in S121, determines not to start providing the currently requested remote operation (S102), and ends the start determination process.

During the provision of the remote control, the MFP 1 is remotely operated by the user of the PC 5 or the PC 7. Since the MFP 1 according to the present embodiment displays the use permission confirmation screen 71 and receives the intention of the user, the user who is using the MFP 1 can wait for the start of the remote operation by operating the "No" button 712 when a screen that is not desired to be viewed is displayed or when printing is in progress. On the other hand, it takes time and effort for the user of the MFP 1 to inquire about the use permission many times. In a case where the start request for any remote operation is rejected and the selection state information 83 is "rejected", the MFP 1 determines that the start request for any remote operation is rejected for that time, and thus the operation is prevented from being complicated.

In a case where the MFP 1 receives the selection of rejection by the user and sets the selection state information 83 to information indicating "rejected", the MFP 1 automatically deletes information indicating "rejected" of the selection state information 83 from the memory 12 for a certain period, for example, one minute. Accordingly, after that, the selection of the user of whether to approve the remote operation is received again. The MFP 1 may receive an instruction to delete "rejected" of the selection state information 83 according to the user operation.

On the other hand, in a case where it is determined that the selection result of the user is approved (S122: approved), the CPU 11 changes the selection state information 83 to be "approved" (S127), and returns the display of the touch panel 131 to a state before the use permission confirmation screen 71 is displayed in S121. Further, the CPU 11 determines to start the requested remote operation (S129), and ends the start determination process.

The remote operation in a state where there is no user in front of the MFP 1 may reduce the safety of the MFP 1. The MFP 1 according to the present embodiment starts the remote operation when an operation on the "Yes" button 711 of the use permission confirmation screen 71 is received, and thus the safety of the remote operation is high. When the user input is not received even after a predetermined time has elapsed after the use permission confirmation screen 71 is displayed, the MFP 1 may not start the remote operation. For example, the MFP 1 may be set to omit reception of an operation on the use permission confirmation screen 71. When the setting to omit is received, the approval may be normally selected. The MFP 1 may be set to start the remote operation when the user input is not received even after the predetermined time has elapsed.

On the other hand, when it is determined that the selection state information 83 is information indicating "in confirmation" (S117: YES), the CPU 11 waits until the selection state information 83 is not "in confirmation" (S131). In a case where the selection state information 83 is "in confirmation" when the current start request is received, the CPU 11 executes the start determination process in response to the start request for the remote operation different from the current start request, displays the use permission confirmation screen 71, and waits for the user input. When the user input is received in the start determination process, as described above, the selection state information 83 becomes information indicating either "rejected" or "approved".

In a case where it is determined that the selection state information 83 is information indicating "rejected" (S131: rejected), the CPU 11 proceeds to S126, changes the state information 81 or 82 corresponding to the current start request to "unused", and determines not to start the remote operation based on the current start request (S102). When the input of the user to the use permission confirmation screen 71 is a selection indicating rejection, the CPU 11 does not start any of the previously requested remote operation and the currently requested remote operation.

In a case where it is determined that the selection state information 83 is information indicating "approved" (S131: approved), or in a case where the selection state information 83 is information indicating "approved" when the start instruction is received (S115: YES), the CPU 11 determines to start the remote operation based on the current start request (S129).

In the start request for the cloud remote operation, as described above, the password input in A01 of FIG. 4 is stored as the parameter 2025 illustrated in FIG. 5A. The MFP 1 collates a password included in the instruction data downloaded in A22 of FIG. 4 with the password 252 of the identification information 25 stored in the memory 12, and determines whether the password is correct, for example, whether two passwords correspond to each other. When determining that the password is not correct, the MFP 1 may determine not to start the cloud remote operation without executing the start determination process.

The password 252 may be a password necessary for local operation of the MFP 1. For example, when the user of the branch office needs to log in to the MFP 1 to operate the MFP 1, the password 252 may be a password that needs to be input via the user IF 13 in order to log in to the MFP 1. The password 252 may be a password for starting the cloud remote operation and may be different from the password used when the MFP 1 is used.

With respect to the password necessary for local operation of the MFP 1, the MFP 1 may enter an account-locked state when the local log-in authentication involving the password input fails a predetermined number of times or more. When the MFP 1 enters an account-locked state, the CPU 11 may determine not to start the remote operation without collating the password stored in the record R1 with the password 252. When the determination that the password is not correct is repeated a predetermined number of times or more in the start request for the cloud remote operation, the CPU 11 may set the MFP 1 in the account-locked state. The MFP 1 may automatically cancel the account-locked state with a predetermined trigger after a predetermined time elapses or the like.

As described above, in the remote operation system 100, the password 252 for providing the cloud remote operation is stored in the MFP 1, and the MFP 1 performs authentication using the password 252. Therefore, the safety of the cloud remote operation is high. On the other hand, in the start request for the local remote operation, since the MFP 1 receives access using access information to the EWS 80 of the MFP 1, the MFP 1 may not request a password.

The MFP 1 according to the present embodiment is configured to start the local remote operation while providing the cloud remote operation, and is configured to start the cloud remote operation while providing the local remote operation. In the case of "YES" in S115 or in the case of "approved" in S131, the MFP 1 receives a start request for another remote operation before the current start request, and executes the start determination process based on the start request. When one of the cloud remote operation and the local remote operation is approved by the user of the MFP 1, the MFP 1 determines that the other is also approved. The MFP 1 provides both remote operations. In the following description, a remote operation for which the start request is received first may be referred to as a primary remote operation, and a remote operation for which the start request is received after the primary remote operation may be referred to as a secondary remote operation.

Returning to the description of the start instruction procedure in FIG. 4. First, a procedure in a case where it is determined to start the cloud remote operation (S129) in the start determination process illustrated in FIG. 6 and the cloud remote operation is provided as the primary remote operation will be described. That is, the following procedure is executed when there is a start request for the cloud remote operation and it is determined to start the cloud remote operation in the start determination process by the MFP 1 in a state where neither the cloud remote operation nor the local remote operation is being provided.

When the MFP 1 downloads the instruction data indicating the start instruction of the cloud remote operation in A22 and determines to start the cloud remote operation in the start determination process illustrated in FIG. 6 (alt: [start]), the MFP 1 requests the non-structured storage 201 or the structured storage 202 to delete the data related to the cloud remote operation (A31). For example, when data uploaded by the previous cloud remote operation remains, there is a possibility of confusion with an instruction related to the current cloud remote operation. When the cloud remote operation is started, the MFP 1 deletes the data remaining in the non-structured storage 201 or the structured storage 202, thereby avoiding an influence of the previous cloud remote operation.

Thereafter, the MFP 1 creates, in the non-structured storage 201, the folder 2011 (see FIG. 2) for a host device to be used in the current cloud remote cloud remote operation (A32). For example, the MFP 1 creates the folder 2011 whose folder name includes its own device ID 251 (see FIG. 2). If the folder 2011 has been created, the MFP 1 may delete all the data in the folder in A31 and skip A32. Furthermore, as described above, the MFP 1 creates the host folder access information 243 for accessing the folder 2011 created in A32 in the non-structured storage 201 (A33). The host folder access information 243 is in the form of a URL. The MFP 1 may store the created host folder access information 243 in the memory 12. Thereafter, even if there is no particular description, the MFP 1 accesses the folder 2011 created in the non-structured storage 201, using the host folder access information 243.

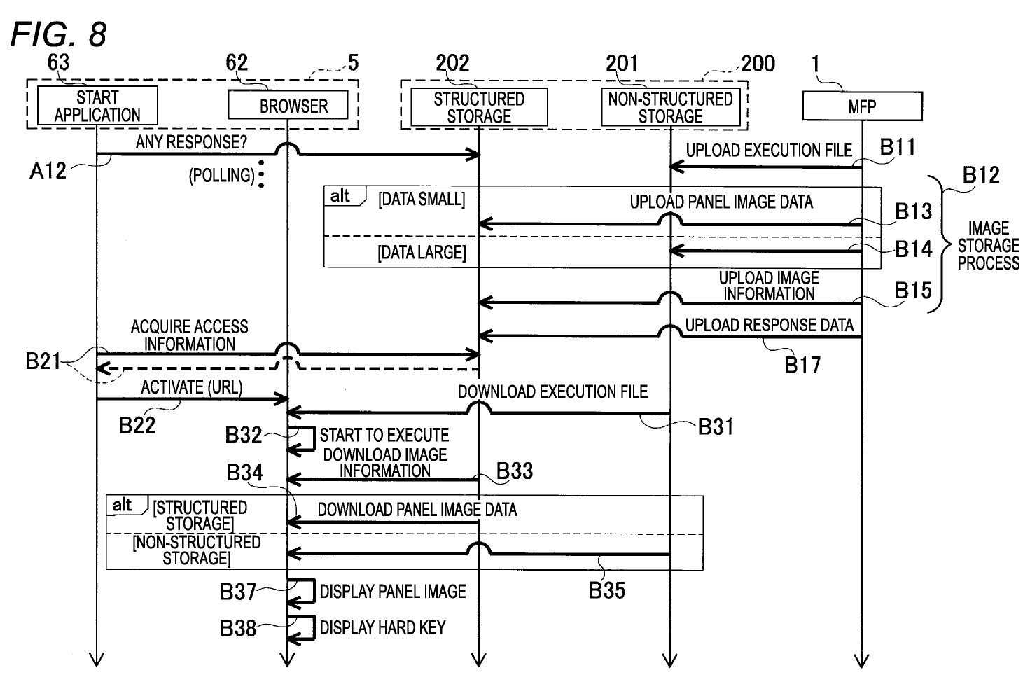

The MFP 1 and the PC 5 execute a screen preparation procedure, which is a procedure for causing the user IF 53 of the PC 5 to display a screen for virtually reproducing the user IF 13 of the MFP 1 that receives the cloud remote operation (A35). The screen preparation procedure will be described with reference to a sequence diagram of FIG. 8.

The MFP 1 uploads the execution file 26 (see FIG. 1) to the folder 2011 created in the non-structured storage 201 in A32 in FIG. 4, using the host folder access information 243 created in A33 (B11). That is, the MFP 1 arranges the execution file 26 in the folder 2011.

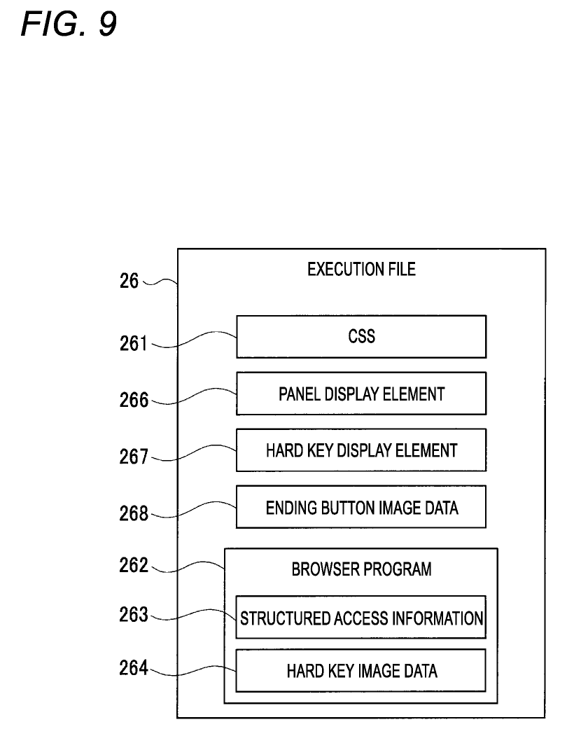

For example, as illustrated in FIG. 9, the execution file 26 includes a CSS 261 and a browser program (hereinafter referred to as "browser P") 262, and is one html file described in HTML. The CSS 261 is information for setting a layout such as a color, a size, a background, and an arrangement of characters of a Web page to be displayed, in order to display, on the browser 62 of the PC 5, an image for virtually reproducing the user IF 13 of the MFP 1. A browser P 262 is, for example, a program described in JavaScript (registered trademark), is operable by the browser 62, and causes the browser 62 to execute a process for a cloud remote operation. The browser P 262 is an example of a first remote operation program.

Further, structured access information 263 and hard key image data 264 are embedded in the browser P 262 of the execution file 26. The structured access information 263 is information used for the browser P 262 to access an area available for the MFP 1 in the structured storage 202, and is in the form of a URL. The structured access information 263 embedded in the execution file 26 may be the same as or partially different from the structured storage access information 242 stored in the MFP 1. The structured access information 263 may be information generated by the CPU 11 of the MFP 1 based on an account name, a token, and the like included in the structured storage access information 242.

The hard key image data 264 is a plurality of pieces of image data corresponding to hard keys 132 included in the user IF 13, and is described in a gif format, for example. The hard key image data 264 includes, for example, icon images indicating the hard keys 132.

By uploading the execution file 26 including the structured access information 263 for accessing the structured storage 202, the PC 5 that downloads the execution file 26 in a later procedure can acquire the browser P 262 and the structured access information 263. Therefore, the PC 5 can access the structured storage 202 using the structured access information 263, based on the process by the browser P 262.

Further, the execution file 26 includes, for example, a panel display element 266, a hard key display element 267, and ending button image data 268 as illustrated in FIG. 9. The panel display element 266 is an image embedding element for causing the browser P 262 to display a panel image for virtually reproducing an image displayed on the touch panel 131 of the MFP 1. The hard key display element 267 is an image embedding element for causing the browser P 262 to display key images for virtually reproducing the hard keys 132 of the MFP 1. The ending button image data 268 is image data for displaying, on the browser P 262, an ending button 533 to be described later.

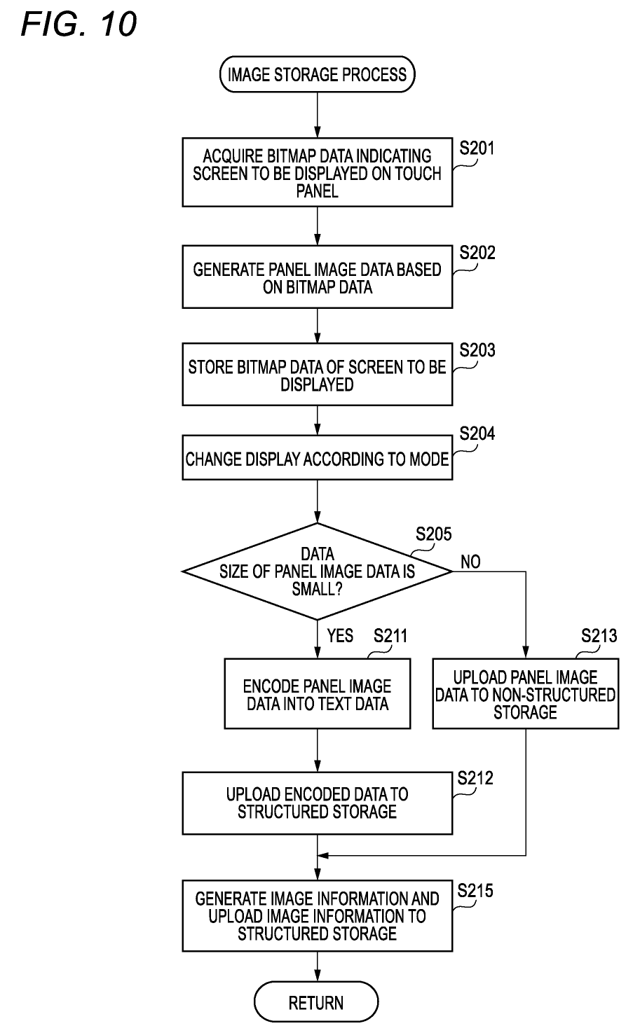

Further, the MFP 1 executes an image storage process (B12). A procedure of the image storage process will be described with reference to a flowchart in FIG. 10. The image storage process is a process for causing the user IF 53 of the PC 5 to display a panel image for virtually reproducing a screen to be displayed on the touch panel 131 of the user IF 13 of the MFP 1. In the image storage process, the MFP 1 uploads, to the cloud storage service 200, panel image data indicating a panel image to be displayed. The image storage process is executed by the CPU 11 of the MFP 1 when it is necessary to upload the panel image data.

The MFP 1 can display, for example, a screen including a plurality of icons on the touch panel 131 in a state where neither the cloud remote operation nor the local remote operation is being provided. In a state where neither the cloud remote operation nor the local remote operation is being provided, the MFP 1 can receive an execution instruction of a process indicated by an icon by an operation on an area where the icon is displayed on the currently displayed screen.

For example, in a case where an operation on a copy icon included in a currently displayed standby screen on the touch panel 131 is received, the MFP 1 displays a setting screen including an icon for instructing a setting change of a copy process, an input field of a setting value to be changed, an icon for instructing execution of the copy process, and the like. The MFP 1 changes the setting of the copy process when receiving an instruction operation related to the setting change. In a case where the MFP 1 receives an operation on an icon for instructing execution of the copy process, the MFP 1 starts execution of the copy process. The icon displayed on the touch panel 131 is an example of an operator. The operation on the copy icon, the operation on the icon for instructing the setting change, an input of a setting value to an input field, the operation on the icon for instructing the execution of the copy process, and the like are examples of the operation related to the image formation, and the copy process is an example of an image forming process. An icon capable of receiving an operation related to image formation is an example of a specific operator.

In a case where an operation on the hard key 132 included in the user IF 13 is received in a state where neither the cloud remote operation nor the local remote operation is being provided, the MFP 1 can execute a process based on the received hard key 132. For example, upon receiving an operation on the return key, the MFP 1 can stop a process of the previously received operation and return to a state before the reception. For example, upon receiving the operation on the return key in a state where a setting screen of the copy process is displayed, the CPU 11 causes the touch panel 131 to display a previous screen, for example, a standby screen.

In the image storage process, the CPU 11 first acquires bitmap data indicating a screen to be displayed on the touch panel 131 (S201). The screen to be displayed on the touch panel 131 is a screen displayed on the touch panel 131 at that time as long as neither the cloud remote operation nor the local remote operation is being provided. The MFP 1 may change the screen to be displayed according to the execution of various types of processes. When the provision of at least one of the cloud remote operation and the local remote operation is started, the MFP 1 does not necessarily display the screen to be displayed on the touch panel 131. The screen displayed on the touch panel 131 during the provision of the remote operation will be described later.

Here, the bitmap data will be supplementarily described. When displaying various screens on the touch panel 131, the MFP 1 generates bitmap data indicating a screen for display. The MFP 1 stores image data serving as a component of each screen in the memory 12 as, for example, the display image data 22 (see FIG. 1). The MFP 1 reads, from the display image data 22, image data to be a component of a screen to be displayed, such as image data indicating a background image of each screen and image data indicating an icon, and generates image data indicating a screen and bitmap data using the read image data.

Different screen IDs are provided on different screens such as a standby screen and a copy setting screen. The MFP 1 can identify the role of the currently displayed screen according to the screen ID. For example, during the display of the standby screen, the MFP 1 temporarily stores, in the memory 12, the screen ID of the standby screen as the screen ID of the currently displayed screen. When the display is switched to the copy setting screen, the MFP 1 generates the bitmap data indicating the copy setting screen, and temporarily stores a screen ID indicating the copy setting screen in the memory 12 as the screen ID of the currently displayed screen.

When an input of a setting value to an input field is received during the display of a copy screen, the MFP 1 generates bitmap data indicating a copy setting screen in which the content of the input field is changed to indicate the input setting value without changing the screen ID of the currently displayed screen. As described above, in a case where the content of the screen is changed during the display of several screens, for example, in a case where a mode of an icon is changed and how many text displays are changed, the MFP 1 generates bitmap data indicating a screen whose content is changed without changing the screen ID of the currently displayed screen. In many cases, a screen having a significantly different role, that is, a screen having a different screen ID often has a significantly different layout. For example, even when the screen IDs are different, such as a copy setting screen and a scan setting screen, the entire layout is similar.

After the provision of the cloud remote operation is started, in S201 of a first image storage process, the CPU 11 acquires bitmap data indicating a currently displayed screen on the touch panel 131 at the time of receiving the start request for the cloud remote operation. The first image storage process is a process executed in the screen preparation procedure (A35 in FIG. 4) following the start determination process.

The CPU 11 generates panel image data, which is image data to be displayed on the user IF 53 of the PC 5 in a later procedure, based on the bitmap data acquired in S201 (S202). For example, the CPU 11 compresses the obtained bitmap data to generate PNG data. The CPU 11 stores the bitmap data acquired in S201 in the memory 12 (S203).

Further, the CPU 11 changes a display screen displayed on the touch panel 131 according to the operation mode (S204). The MFP 1 has three types of modes, that is, a first mode, a second mode, and a third mode, as operation modes in a case of providing a cloud remote operation or a local remote operation. The three types of modes are different from each other in a configuration of a screen displayed on a user IF of the PC 5, the PC 7, or the like, which is a device for performing a remote operation, or a configuration of a screen displayed on the touch panel 131 of the MFP 1. An operation mode of the MFP 1 may be designated by user designation via the EWS 80, or the MFP 1 may operate in a predetermined operation mode.

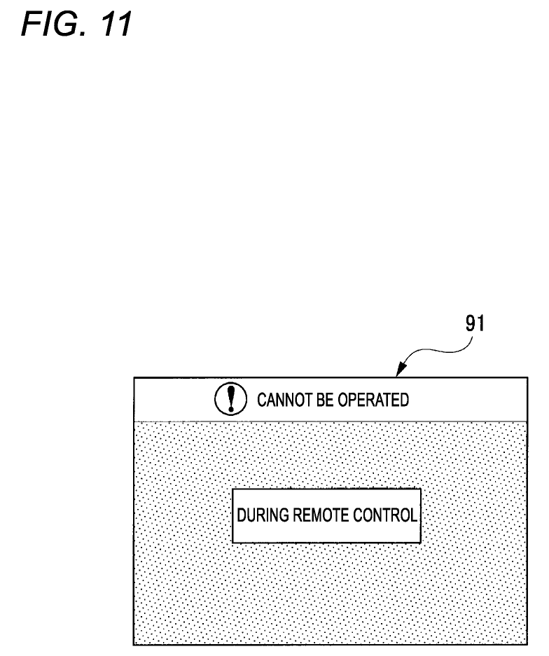

When the operation mode is the first mode or the second mode, the CPU 11 causes the touch panel 131 to display a provision-in-progress screen 91 as illustrated in FIG. 11, for example, instead of the screen to be displayed in S204. Hereinafter, the term "screen to be displayed" is also used to mean a screen to be displayed on the touch panel 131 by the CPU 11 if neither the cloud remote operation nor the local remote operation is provided. The provision-in-progress screen 91 is a screen for notifying the user that the remote operation is being provided, and is a screen that does not include an operator, such as an icon or a button. Even if the MFP 1 receives an operation on the touch panel 131 or the hard key 132 while the provision-in-progress screen 91 is currently displayed, the MFP 1 does not execute a process based on the received operation. The MFP 1 may ignore the received operation, or may notify, by a warning sound or the like, that the operation cannot be received. The provision-in-progress screen 91 is an example of a remote operation in-progress screen. By displaying the provision-in-progress screen 91, it is easy to understand that an operation on the touch panel 131 is not received.

On the other hand, when the operation mode is the third mode, the CPU 11 does not change the display screen and keeps displaying the screen to be displayed. That is, when operating in the third mode, the CPU 11 displays a currently displayed screen on the touch panel 131 as it is at the time of receiving the start request for the cloud remote operation even after the execution of the first image storage process. The display screen in the case of the third mode is a screen including an operator such as an icon or a button similar to a state where neither the cloud remote operation nor the local remote operation is being provided. In the case of the third mode, the CPU 11 may or may not receive an operation on a currently displayed screen on the touch panel 131.

In S203, the CPU 11 stores data indicating a screen to be displayed regardless of the operation mode. In S201 of the image storage process executed in the subsequent procedure, the CPU 11 reads out the bitmap data stored in the memory 12 in S203 or in a separate process to be described later, thereby acquiring bitmap data indicating the screen to be displayed. The screen to be displayed is an example of a main body operation screen, and is an example of a main body operation screen.

The data indicating the screen to be displayed is not limited to bitmap data, and may be PNG data or JPEG data, for example. The panel image data is not limited to data indicating a screen, such as bitmap data, and may be data indicating a screen. Instead of creating the panel image data from the data indicating the screen, the CPU 11 may acquire image data serving as a component included in the currently displayed screen on the touch panel 131 and create the panel image data using the obtained image data.

When a moving image or an animation is included in the screen to be displayed, the CPU 11 may generate panel image data not including the moving image or the animation, or may generate the panel image data to which one scene of the moving image or the animation is added as a still image. The moving image or the animation tends to have a large amount of data and a high communication load. Since the MFP 1 according to the present embodiment generates panel image data not including a moving image, it is possible to reduce an increase in communication failure.

The CPU 11 determines whether a data size of the generated panel image data is smaller than a predetermined size (S205). The panel image data to be uploaded has, for example, different compression effectiveness for each type of screen, and a data size after compression may or may not be large. For example, a screen including only an icon and a menu such as a standby screen tends to be reduced in size by compression, whereas a screen including a print preview image and a scan result image tends to have a large data size. The data size of data that can be stored in each record of the structured storage 202 is limited by the cloud storage service 200.

If it is determined that the size is smaller than the predetermined size (S205: YES), the CPU 11 encodes the panel image data in a text data format according to a predetermined rule (S211). In the structured storage 202, since the text data format is suitable as the format of data stored in each record, the CPU 11 encodes the panel image data into the text data format. However, if the data format suitable for storing in the structured storage 202 is defined in the cloud storage service 200 in addition to the text data format, the CPU 11 may encode the panel image data in the data format. If the format of the panel image data is a data format suitable for storing in the structured storage 202, the CPU 11 may not encode the panel image data.

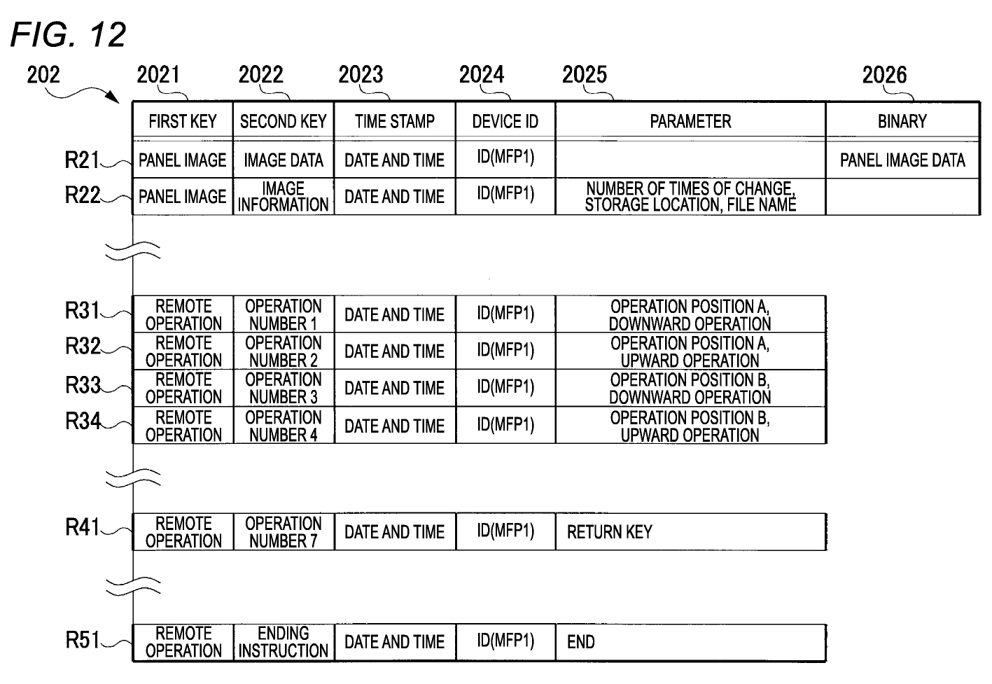

The CPU 11 uploads the encoded panel image data to the structured storage 202 (S212, B13 in FIG. 8). Specifically, the MFP 1 uploads each piece of information to the structured storage 202, for example, as a record R21 illustrated in FIG. 12. That is, the MFP 1 uploads each piece of information to the structured storage 202 such that the device ID of the MFP 1 is stored in the device ID 2024 of a record in which information indicating a panel image is stored in the first key 2021 and information indicating image data is stored in the second key 2022, and the panel image data encoded in the text data format is stored in the binary 2026. S212 and B13 in FIG. 8 are examples of an image upload process. The panel image data uploaded in S212 and B13 in FIG. 8 is an example of first image data.

On the other hand, if it is determined that the data size of the panel image data is not smaller than the predetermined size, that is, if it is determined that the panel image data cannot be stored in the record of the structured storage 202 (S205: NO), the CPU 11 accesses the folder 2011 of the non-structured storage 201 using the above-described host folder access information 243 (see FIG. 2) and uploads the panel image data to the non-structured storage 201 (S213, B14 in FIG. 8). S213 and B14 in FIG. 8 are examples of the image upload process. The panel image data uploaded in S213 and B14 in FIG. 8 is an example of the first image data.

That is, the MFP 1 creates a file including the panel image data and uploads the file to the folder 2011 generated in A32 of FIG. 4. The folder 2011 is a folder whose folder name includes the device ID of the MFP 1. In this case, the MFP 1 does not upload the panel image data to the structured storage 202. That is, the panel image data is not stored in the record R21.

The panel image data uploaded to the structured storage 202 or the non-structured storage 201 is read by the browser 62 of the PC 5 in a procedure to be described later. The panel image data includes image data indicating a screen for virtually reproducing, on the user IF 53 of the PC 5, a screen displayed on the user IF 13 of the MFP 1. By using the cloud storage service 200, an upload destination is selectively used according to the size of the image data. Therefore, even when the panel image data has a large data size, the panel image data can be passed to the browser 62 via the cloud storage service 200.

Further, the CPU 11 generates image information, which is information related to the uploaded panel image data, and uploads the image information to the structured storage 202 (S215, B15 in FIG. 8). For example, the MFP 1 uploads the image information to the structured storage 202 as a record R22 illustrated in FIG. 12. That is, the MFP 1 uploads each piece of information to the structured storage 202 such that the device ID of the MFP 1 is stored in the device ID 2024 of a record in which the information indicating the panel image is stored in the first key 2021 and the information indicating the image information is stored in the second key 2022, and information indicating the number of times of change in the panel image data, information indicating a storage location of the panel image data, and information indicating a file name of the panel image data are stored in the parameter 2025.

The information indicating the storage location of the panel image data includes information indicating whether the panel image data is stored in the record R21 or the panel image data is uploaded to the folder 2011 of the non-structured storage 201. Hereinafter, for convenience, information stored in the parameter 2025 of the record R22, that is, the information indicating the number of times of change in the panel image data, the information indicating the storage location of the panel image data, and the information indicating the file name of the panel image data will be described as image information.

Since the panel image data uploaded in B13 or B14 in FIG. 8 is the first panel image data of the current cloud remote operation, the MFP 1 sets the number of times of change included in the image information uploaded in B15 to "1". Although details will be described later, the MFP 1 may upload the panel image data again in the following procedure, and store the number of times of change obtained by adding one by one in the record of the image information each time the panel image data is uploaded.

The record R21 for storing the panel image data and the record R22 for storing the image information are paired records for uploading one piece of panel image data. Although not illustrated, another pair of record pairs are prepared in the structured storage 202 in the same manner as the record pair of the record R21 and the record R22. When uploading the information related to the panel image data in the subsequent times, the MFP 1 uploads the information related to the panel image data to the record of the record pair having the smaller number of times of change stored among the two pairs of record pairs. That is, the MFP 1 alternately uploads the two record pairs. The MFP 1 may upload the information related to the panel image data to the record pair whose stored time stamp is older.

There may be three or more pairs of record pairs for storing information related to the panel image data. In this case, the MFP 1 may upload the information related to the panel image data to the record of the record pair having the smallest number of times of change stored therein. Alternatively, the MFP 1 may upload the information related to the panel image data to the record pair whose stored time stamp is oldest.

When the MFP 1 determines that the panel image data has a size that cannot be stored in the record of the structured storage 202, the MFP 1 may divide the panel image data into a plurality of pieces of data and upload the divided data into a plurality of records of the structured storage 202, instead of uploading the data to the non-structured storage 201. For example, the MFP 1 may divide the panel image data into data indicating an upper half of the screen and data indicating a lower half of the screen, and upload the divided data to store the divided data in two records. The MFP 1 may determine the number of divisions according to the data size of the panel image data. In this case, the MFP 1 may encode each of the plurality of pieces of divided panel image data into a text data format, store the encoded data in a plurality of records, and store information indicating the number of divisions and information indicating the order of each record as image information. Even in this case, by uploading the divided data according to the data size of the panel image data, image data having a large size can be passed to the browser 62 via the cloud storage service 200 in a subsequent procedure.

After S215, CPU 11 ends the image storage process of FIG. 10 and returns to the screen preparation procedure in FIG. 8. In FIG. 8, a procedure when the panel image data is uploaded to the structured storage 202 (S212 in FIG. 10) in the image storage process of B12 is indicated by B13, and a procedure when the panel image data is uploaded to the non-structured storage 201 (S213 in FIG. 10) is indicated by B14. A procedure for uploading the image information to the structured storage 202 (S215 in FIG. 10) is indicated by B15.

Returning to the description of the screen preparation procedure in FIG. 8. After uploading the execution file 26 in B11 and uploading the panel image data and the image information in B12, the MFP 1 uploads response data indicating that the process is completed to the structured storage 202 in response to the instruction data acquired in A22 of FIG. 4 (B17). After B17, the MFP 1 enters a providing state where the cloud remote operation is being provided until an ending condition for ending the cloud remote operation is satisfied. The providing state of the cloud remote operation is an example of a second remote operation providing state. After uploading the response data, the MFP 1 may execute the image storage process in B12.

For example, the MFP 1 uploads the response data such that the response data is stored in the record R1 (see FIGS. 5A to 5D) including the instruction data. Specifically, for example, as illustrated in FIG. 5C, the MFP 1 uploads each piece of information such that information indicating "ending" is stored in the record R1 as a progress status, information indicating "success" is stored as a result, and access information for downloading the execution file 26 uploaded in B11 is stored as additional information 2027.

The access information stored in the additional information 2027 of the record R1 is information for accessing the folder 2011 whose folder name includes the device ID of the MFP 1, which is created in the non-structured storage 201. The access information stored in the additional information 2027 is in the form of a URL. The access information stored in the additional information 2027 may be the same as or partially different from the host folder access information 243 created in A33. The MFP 1 may store the host folder access information 243 in the additional information 2027 as it is. For example, the MFP 1 may combine the non-structured storage access information 241 and the device ID 251 stored in the memory 12 to create access information stored in the additional information 2027.

On the other hand, as described above, after uploading the record R1 including the instruction data in A11, the start application 63 of the PC 5 periodically accesses the structured storage 202 and monitors the presence or absence of a response to the instruction according to the record R1 (A12). When the information on the progress status included in the record R1 changes from "executing" to "ending", if the information indicating "success" is stored as a result, the start application 63 can start the cloud remote operation.

The start application 63 acquires access information from the additional information 2027 of the record R1 in which the information indicating "success" is stored (B21). The start application 63 further activates the browser 62 and passes the access information acquired from the additional information 2027 to the activated browser 62 (B22).

The browser 62 downloads the execution file 26 from the folder 2011 of the non-structured storage 201 by non-anonymous access using the access information passed from the start application 63 (B31). As described above, the execution file 26 includes the CSS 261, and the browser 62 sets a display configuration of a Web page based on the CSS 261 of the acquired execution file 26. Since the execution file 26 includes the browser P 262, the browser 62 starts executing a process based on the browser P 262 (B32).

Further, since the structured access information 263 is included in the execution file 26, the browser 62 accesses the structured storage 202 using the structured access information 263 and downloads the image information (B33). The image information is information uploaded by the MFP 1 in B15. The browser 62 downloads the image information from the record in which image information having the number of times of change of "1" is stored in B33. As described above, the MFP 1 uploads the record R22 such that the image information having the number of times of change of "1" is stored in B15 of FIG. 8. The browser 62 downloads the image information stored in the record R22.

That is, by downloading the execution file 26, the browser 62 can acquire the structured access information 263 and access the structured storage 202 using the structured access information 263. Accordingly, it is not necessary to prepare the structured access information 263 at the start application 63. The start application 63 may be configured to generate the structured access information 263 and pass the information to the browser 62.

The browser 62 downloads the panel image data from the structured storage 202 or the non-structured storage 201, based on the information stored in the parameter 2025 of the record R22 of the image information (B34 or B35). If the storage location of the panel image data is the structured storage 202 (alt: [structured storage]), the browser 62 downloads the panel image data stored in the record R21 of the structured storage 202 (B34). If the storage location of the panel image data is the non-structured storage 201 (alt: "non-structured storage"), the browser 62 downloads the panel image data stored in the folder 2011 of the non-structured storage 201 (B35).

As described above, when the data size of the panel image data is large, the MFP 1 may divide the panel image data and upload the panel image data to the structured storage 202, instead of uploading the panel image data to the non-structured storage 201. In this case, the browser 62 can acquire panel image data by downloading a plurality of pieces of panel image data divided from the structured storage 202 based on the image information and integrating the plurality of pieces of panel image data based on the image information.

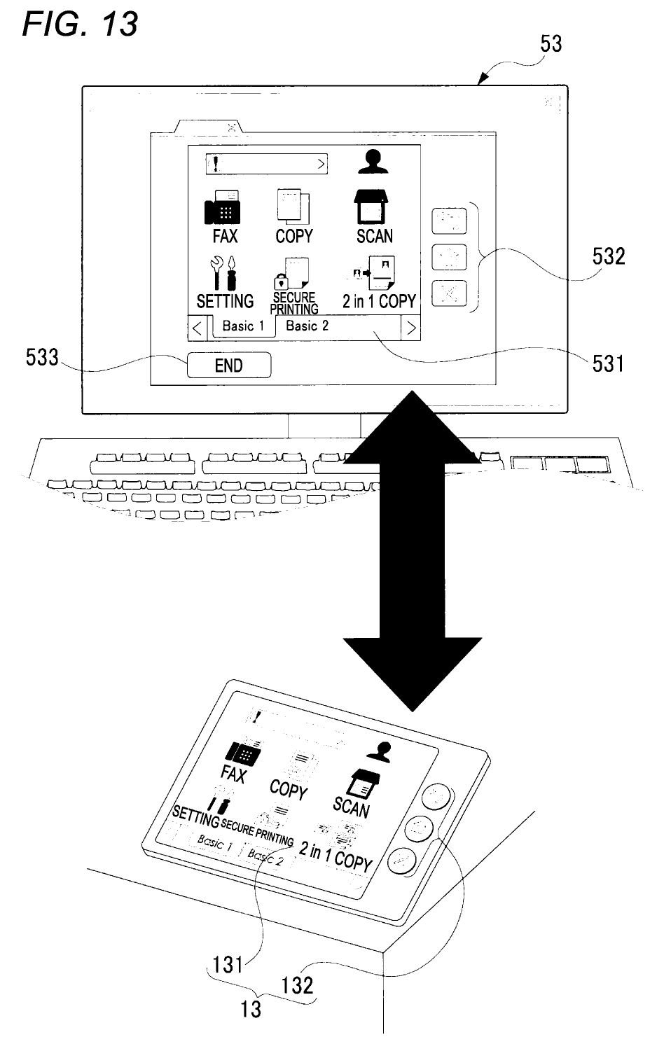

For example, as illustrated in FIG. 13, the browser 62 displays a panel image 531 at a position of the user IF 53 corresponding to the panel display element 266 based on the downloaded panel image data (B37). The panel image 531 is an example of a first remote operation screen, and B37 is an example of a screen display process. The panel image 531 displayed on the user IF 53 of the PC 5 is an image for virtually reproducing a screen to be displayed on the touch panel 131 of the user IF 13 of the MFP 1 at that time.

Further, for example, as illustrated in FIG. 13, the browser 62 displays key images 532 at positions of the user IF 53 corresponding to the hard key display element 267 based on the hard key image data 264 (B38). The three key images 532 displayed on the user IF 53 of the PC 5 are images corresponding to the respective three hard keys 132 included in the user IF 13 of the MFP 1. Thus, an image for virtually reproducing the user IF 13 of the MFP 1 including the touch panel 131 and the hard keys 132 is displayed on the user IF 53 of the PC 5.

Although FIG. 13 illustrates an example in which the standby screen is displayed, a screen displayed in B37 is a screen for virtually reproducing a screen to be displayed on the touch panel 131 of the MFP 1, and is not limited to the standby screen. For example, when the provision of the cloud remote operation is started in a state where an error occurs in the MFP 1 and an error screen is displayed on the touch panel 131, the error screen is also displayed on the user IF 53 of the PC 5. As described above, when a copy setting screen is displayed on the touch panel 131 at the time when the provision of the cloud remote operation is started, the copy setting screen is also displayed on the user IF 53 of the PC 5.

The screen displayed on the user IF 53 by the browser 62 includes the panel image 531 for virtually reproducing the screen displayed on the touch panel 131 of the MFP 1 and the key images 532 for virtually reproducing the hard keys 132. That is, since an image for virtually reproducing the user IF 13 of the MFP 1 is displayed on the user IF 53 of the PC 5, the user of the PC 5 can perform the same operation as the operation on the MFP 1 through the user IF 53 in the following procedure, and can easily perform a cloud remote operation. The arrangement and the shapes of the key images 532 displayed on the user IF 53 are preferably the same as those on the user IF 13 of the MFP 1, and may be the same as those on the user IF 13 of the MFP 1.

The ending button 533 is further displayed on the user IF 53 of the PC 5. The ending button 533 is a button that is not included in the user IF 13 of the MFP 1, and is operated when the user who is executing the cloud remote operation on the PC 5 instructs to end the cloud remote operation.

Thus, the screen preparation procedure in FIG. 8 (A35 in FIG. 4) ends. Returning to the description of the start instruction procedure in FIG. 4. Next, a procedure when it is determined not to start the cloud remote operation in the start determination process in A23 of FIG. 4 will be described. A procedure after the screen preparation procedure when it is determined to start the cloud remote operation in A23 of FIG. 4 will be described later.

Even when the instruction data indicating the start request for the cloud remote operation by the PC 5 is downloaded, for example, when it is determined that the password included in the instruction data is not correct, the MFP 1 determines not to start the cloud remote operation. As illustrated in FIG. 6, if the cloud remote operation by another PC or the like has already been received (NO in S101), if an operation on the "No" button 712 is received on the use permission confirmation screen 71 (see FIG. 7) (YES in S111 or rejected in S115), MFP 1 determines not to start the cloud remote operation (S102).

When it is determined not to start the cloud remote operation in the start determination process in A23 (alt: "not started"), the MFP 1 does not upload the execution file 26 and uploads information indicating that the cloud remote operation is not started to the structured storage 202 (A41). As illustrated in FIG. 5D, the MFP 1 uploads each piece of information such that information indicating "ending" indicating completion of the process as the progress status and information indicating "failure" as the result are stored in the record R1. The MFP 1 may further store, in the record R14, information indicating the reason why the cloud remote operation is not started.

The start application 63 of the PC 5 monitors the presence or absence of the response data to the instruction of the record R1 (A12), and downloads the response data when the progress status of the record R1 changes from "executing" to "ending" (A43). If the information indicating "failure" is stored as the response data, the start application 63 causes the user IF 53 to display a message indicating that the cloud remote operation is not to be started, for example, denied (A44). Further, the start application 63 deletes the instruction data uploaded in A11 from the structured storage 202 (A45). In this case, the cloud remote operation is not started. For example, a user who wants to perform the cloud remote operation waits for a predetermined time to elapse, or performs an operation such as re-inputting a password to input a start instruction of the cloud remote operation to the start application 63 again.

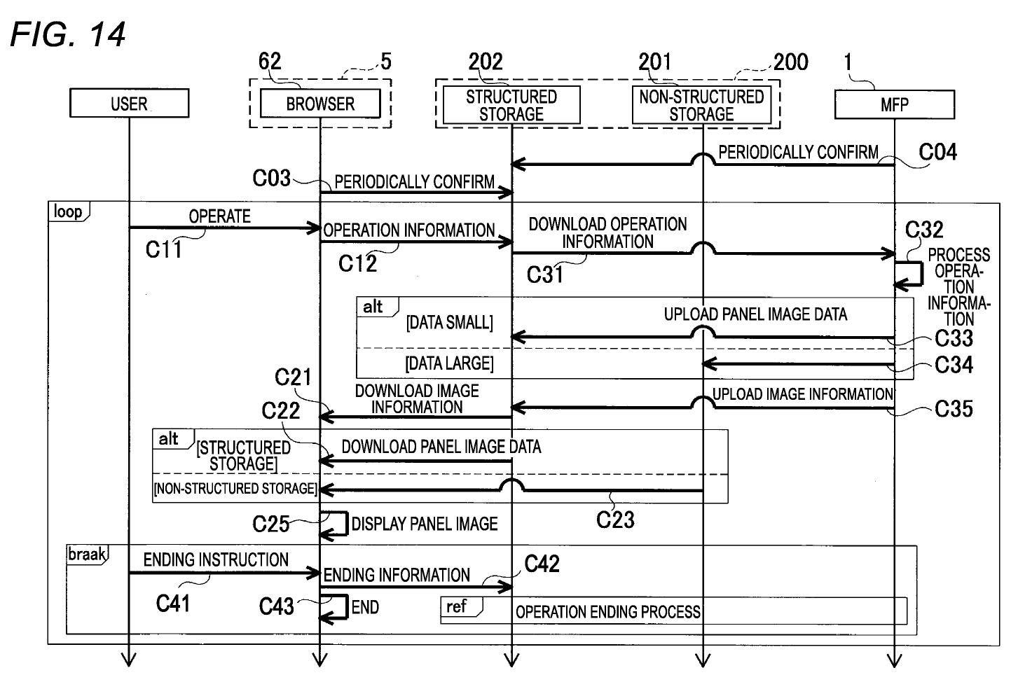

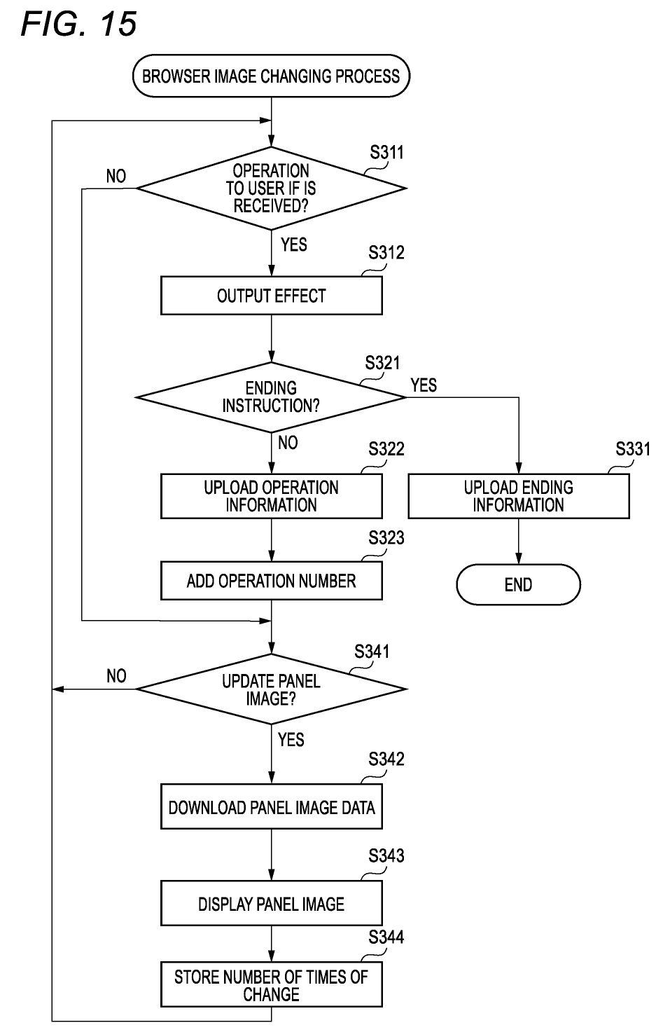

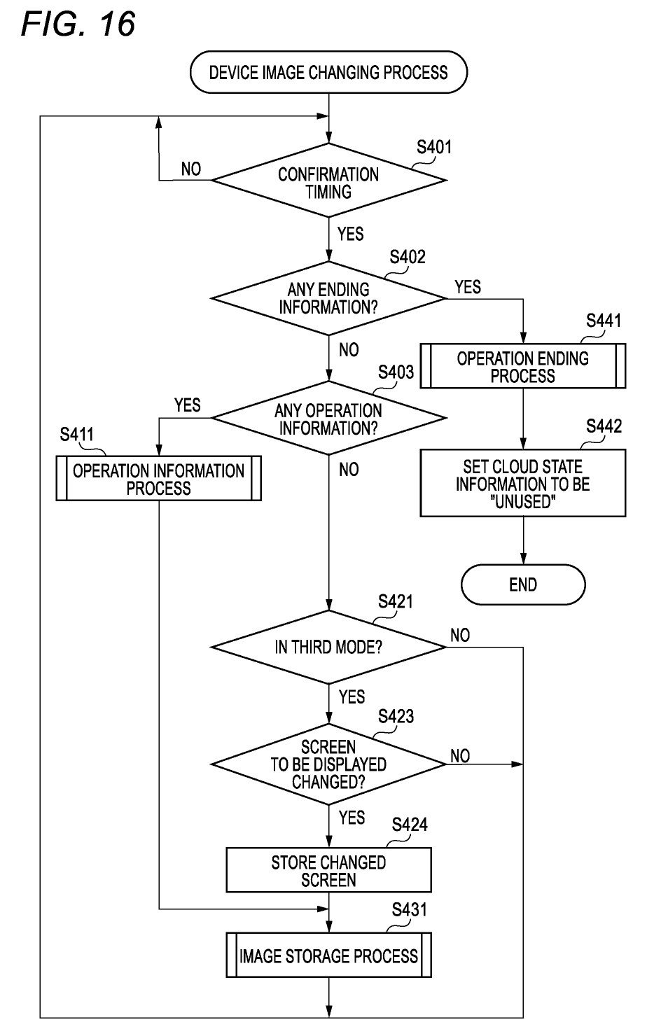

Next, a remote operation procedure which is an operation procedure after the cloud remote operation is started will be described with reference to a sequence diagram of FIG. 14. The remote operation procedure is executed in cooperation with the PC 5 and the MFP 1 after an image for virtually reproducing the user IF 13 of the MFP 1 is displayed on the user IF 53 of the PC 5, as illustrated in FIG. 13, based on B37 and B38 in FIG. 8. In the PC 5, the browser 62 executes a browser image changing process illustrated in FIG. 15 based on the description of the browser P 262 (see FIG. 9) included in the execution file 26 downloaded in B31 of FIG. 8. The MFP 1 executes a device image changing process illustrated in FIG. 16 based on the remote operation program 23.

First, the procedure of the browser image changing process executed by the browser 62 will be described with reference to the flowchart in FIG. 15 and, if necessary, with reference to the sequence diagram of FIG. 14. During execution of the browser image changing process, the browser 62 periodically accesses the structured storage 202 (C03 in FIG. 14), confirms the record R22 (see FIG. 12) in which the image information is stored, and repeats determination as to whether the number of times of change included in the parameter 2025 is updated from the number of times of change stored in the browser 62.

In the browser image changing process, the browser 62 determines whether an operation on one of the currently displayed panel image 531, the key images 532, and the ending button 533 on the user IF 53 is received (S311). If it is determined that the operation on the user IF 53 is received (S311: YES, C11 in FIG. 14), the browser 62 outputs an effect (S312). Specifically, the browser 62 outputs an effect indicating that the operation has been received, by, for example, displaying a small animation or a still image indicated by a mark such as "O" indicating the operated position at an operation point for a short time, changing a display color of the operation point, and outputting an effect sound. By outputting the effect for the operation, the user who performs the operation on the user IF 53 can easily realize the operation.

When the browser 62 receives an operation on any one of a range indicating the panel image 531, a range indicating any one of the key images 532, and a range indicating the ending button 533 in the user IF 53 displaying the panel image 531 illustrated in FIG. 13, the browser 62 determines YES in S311. For example, when an operation to another position is received, the browser 62 may ignore the operation or may execute another process included in the browser 62.

The browser 62 determines whether the received instruction is an operation on the ending button 533, that is, an ending instruction of the cloud remote operation (S321). If it is determined that the received instruction is not the ending instruction of the cloud remote operation (S321: NO), the browser 62 uploads the operation information indicating the received operation to the structured storage 202 to be stored in a record indicating an operation content to be described later (S322, C12 in FIG. 14).

The browser 62 can upload the record in which the operation information is stored to the structured storage 202 using the structured access information 263 (see FIG. 9) included in the execution file 26 downloaded in B31 of FIG. 8. S322 and C12 in FIG. 14 are examples of an operation upload process. S322 and the data uploaded to C12 in FIG. 14 are examples of the first operation data.

Further, the browser 62 adds the stored operation number (S323). The operation number is information indicating the operation order. The browser 62 stores the operation number as 1 at the start of the browser image changing process, that is, at the start of the remote operation procedure.

The operation information is information indicating the operation content of the operation received by the PC 5. For example, as illustrated in FIG. 12, the browser 62 uploads one of a plurality of types of records according to the operation. For example, as in records R31 to R34 and R41 illustrated in FIG. 12, information indicating operation information of the cloud remote operation is stored in the first key 2021 of the record in which the operation information is stored, and information indicating the operation number is stored in the second key 2022. For example, the browser 62 uploads the operation information to the structured storage 202 such that the operation information is stored in a record in which information corresponding to the stored operation number is stored in the second key.

For example, when the stored operation number is 1 and a click on an icon displayed at a position A of the panel image 531 is received, the browser 62 first uploads operation information corresponding to a pressing operation at a time when an operation of pressing a button or the like of a mouse of the click is received (S322). Specifically, the browser 62 uploads the operation information such that the device ID of the MFP 1 is stored in the device ID 2024 and information indicating an operation position and information indicating a downward operation (pressing operation) are stored in the parameter 2025 in the record R31 including information indicating the remote operation in the first key 2021 and the operation number 1 in the second key. The browser 62 adds 1 to the stored operation number and sets the operation number to 2 (S323). The parameters 2025 in the records R31 to R34 and R41 are examples of the first operation data indicating the operation content.

Next, the browser 62 uploads information corresponding to the release operation at a time when an operation of releasing a finger from a button or the like of the click is received (S322). Specifically, the browser 62 uploads the operation information such that the device ID of the MFP 1 is stored in the device ID 2024 and information indicating the same operation position as the record R31 and information indicating an upward operation (release operation) are stored in the parameter 2025 in the record R32 including information indicating the remote operation in the first key 2021 and the operation number 2 in the second key. The browser 62 adds 1 to the stored operation number and sets the operation number to 3 (S323).

As described above, in the records R31 and R32, information indicating that the pressing operation and the release operation of the click are performed at the same operation position, a time stamp for the pressing operation, and a time stamp for the release operation are respectively stored. As described later, the MFP 1 downloads the operation information uploaded by the PC 5 and executes a process according to the downloaded operation information. At this time, for example, the MFP 1 can distinguish between the short press and the long press of the icon by comparing the time stamps 2023 stored in the records R31 and R32. The information indicating the operation position may be information indicating coordinates in the panel image 531 or the touch panel 131 of the corresponding MFP 1, or may be information for identifying the operated button or icon.

For example, when an operation on a key image indicating a return key which is one of the key images 532 is received as an operation when the stored operation number is 7, the browser 62 uploads the operation information such that the device ID of the MFP 1 is stored in the device ID 2024 and information indicating the return key is stored in the parameter 2025 in the record R41 including information indicating a remote operation in the first key 2021 and the operation number 7 in the second key (S322). The browser 62 adds 1 to the stored operation number and sets the operation number to 8 (S323).

In the case of the operation on the key image, the browser 62 uploads the operation information such that not the information indicating the operation direction but the information indicating the operated key is stored in the parameter 2025. The information indicating the key may be information for specifying one of the hard keys 132 of the MFP 1 corresponding to the key images 532 having received the operations, or information indicating the coordinates of the corresponding hard keys 132. In order to make it possible to distinguish between the short press and the long press in the operation on the hard key 132 of the MFP 1, the browser 62 may upload a plurality of pieces of operation information including the information indicating the operation direction in relation to the operation on the key image 532.

After S323 or if it is determined that the operation on the user IF 53 is not received (S311: NO), the browser 62 determines whether to update the currently displayed panel image 531 on the user IF 53 (S341). As described above, the browser 62 periodically accesses the structured storage 202 (C03 in FIG. 14), and determines to update the panel image 531 when the number of times of change stored in the image information increases from the number of times of change stored in the browser 62.

Although details will be described later, a screen to be displayed on the touch panel 131 of the MFP 1 may be changed according to the cloud remote operation from the PC 5. When the image to be displayed on the touch panel 131 is changed, the MFP 1 uploads the image information to the structured storage 202 such that the updated image information is stored in the record R22 of FIG. 12 or a record of another pair of image information. The updated image information includes information on the number of times of change added by the MFP 1.

The number of times of change stored in the browser 62 is the number of times of change included in the image information used for displaying the currently displayed panel image 531 on the browser 62. That is, when the number of times of change that is increased from the stored number of times of change is stored in the image information, the panel image data corresponding to the image information is newer data than the panel image data used for displaying the currently displayed panel image 531 on the browser 62. The browser 62 stores the number of times of change as 1 at the start of the browser image changing process, that is, at the start of the remote operation procedure.

If it is determined that the panel image 531 is to be updated (S341: YES), the browser 62 acquires the panel image data (S342). Specifically, as illustrated in C21 to C23 in FIG. 14, the browser 62 first downloads the image information from the record R22 or a record of another pair of image information (C21), and downloads the panel image data from a record of the structured storage 202 or from the folder 2011 of the non-structured storage 201, based on the parameter of the image information (C22 or C23). C21 to C23 in FIG. 14 are the same processes as B33 to B35 in FIG. 8.

When there are three or more record pairs for storing information related to the panel image data, the browser 62 may download information related to the panel image data stored in a record in which the stored number of times of change is the largest. Alternatively, the browser 62 may download information related to the panel image data stored in a record in which the stored time stamp is the newest.

Further, the browser 62 displays the updated panel image 531 on the user IF 53, based on the downloaded panel image data (S343, C25 in FIG. 14). When the screen to be displayed in MFP 1 is changed, the panel image 531 displayed on the user IF 53 of the PC 5 is similarly changed. An image to be changed is only the range of the panel image 531, and the browser 62 does not change the displayed key images 532 and the ending button 533. Further, the browser 62 stores the number of times of change included in the image information (S344).

That is, in a case where an event as a trigger for changing a screen to be displayed occurs, the MFP 1 uploads the panel image data and updates the image information. When the image information is updated, the browser 62 downloads the panel image data and updates the panel image 531.

When the display of the panel image 531 based on the information downloaded in C21 to C23 fails, the browser 62 maintains the display of the panel image 531 originally displayed. At this time, if it is necessary to maintain the display, the browser 62 may download the information downloaded at the previous B33 to B35 or C21 to C23 again.

After S344 or if it is determined that the panel image 531 is not to be updated (S341: NO), the browser 62 proceeds to S311, repeats the determination of whether an operation on the user IF 53 is received (S311) and the determination of whether the panel image 531 is to be updated (S341) (loop of FIG. 14).

On the other hand, if it is determined that the operation on the user IF 53 is received (S311: YES) and the instruction by the received operation is the ending instruction of the cloud remote operation (S321: YES), that is, when an operation on the ending button 533 illustrated in FIG. 13 is received (C41 in FIG. 14), the browser 62 uploads ending information to the structured storage 202 (S331, C42 in FIG. 14).

Specifically, for example, as illustrated in FIG. 12, the browser 62 uploads the ending information such that information indicating that the ending instruction of the cloud remote operation of the MFP 1 is received is stored in the parameter 2025 of a record R51 in which information indicating the operation information of the cloud remote operation is stored in the first key 2021 and information indicating the ending instruction is stored in the second key 2022. The ending information may be information indicating an operation on the ending button 533. S331 is an example of the operation upload process. Thereafter, the PC 5 ends the browser image changing process and ends the cloud remote operation of the MFP 1 (C43 in FIG. 14, break).

After the cloud remote operation is ended, the MFP 1 does not upload the panel image data. The PC 5 may end the browser 62, may end the execution of the process according to the browser P 262 and display another Web page, or may display a blank screen. The downloaded execution file 26 may be deleted when the browser 62 is ended or may be spontaneously deleted in response to the end of execution.

Next, a procedure of the device image changing process executed by the MFP 1 when the cloud remote operation is started will be described with reference to a flowchart in FIG. 16 and, if necessary, the sequence diagram of FIG. 14. As described above, the device image changing process is executed by the CPU 11 of the MFP 1 after uploading the execution file 26 and the image data and uploading the response data indicating "success" to the structured storage 202 (B11 to B17 in FIG. 8).

In the device image changing process, the CPU 11 determines whether a periodic confirmation timing has come (S401). During execution of the cloud remote operation, the MFP 1 periodically accesses the structured storage 202 as with the browser 62 of the PC 5 (C04 in FIG. 14). If the periodic confirmation timing has not come (S401: NO), the CPU 11 repeats the determination in S401. A confirmation timing by the MFP 1 and a confirmation timing by the browser 62 may not be the same.

If it is determined that the periodic confirmation timing has come (S401: YES), the CPU 11 confirms whether the ending information including its own device ID is uploaded to the structured storage 202 (S402). If it is determined that the ending information is not uploaded (S402: NO), the CPU 11 determines whether the operation information including its own device ID is uploaded to the structured storage 202 (S403). When an operation by the user of the PC 5 is received, the operation information is uploaded to the structured storage 202 in the browser image changing process (S322 in FIG. 15, C12 in FIG. 14) according to the above-described procedure.

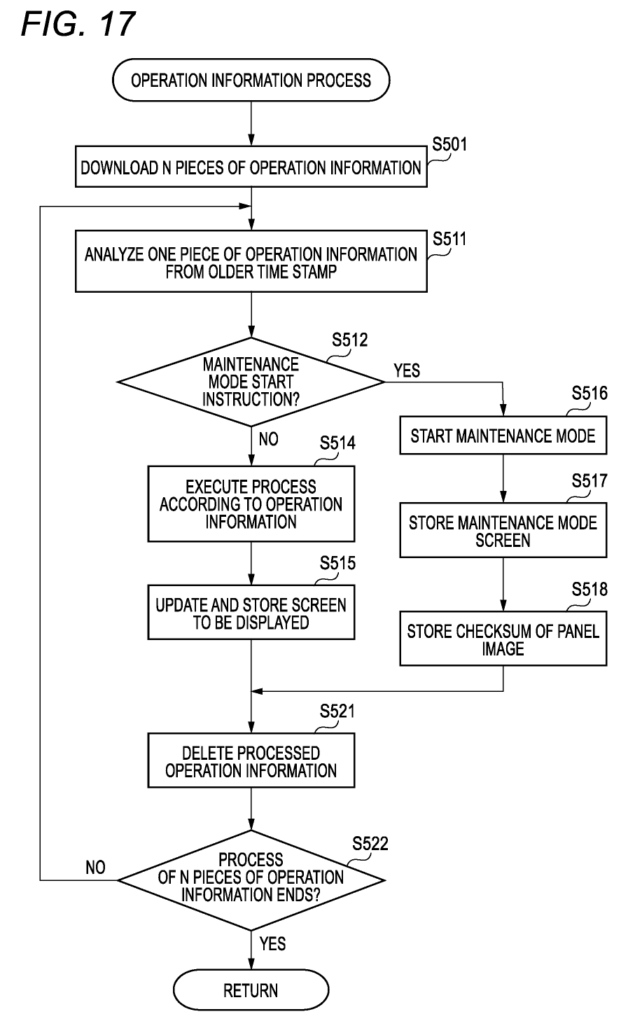

If it is determined that the operation information is uploaded to the structured storage 202 (S403: YES), the CPU 11 executes an operation information process (S411). A procedure of the operation information process will be described with reference to a flowchart in FIG. 17 and, if necessary, the sequence diagram of FIG. 14.

In the operation information process, the CPU 11 acquires up to N pieces of operation information uploaded to the structured storage 202 by downloading the N pieces of operation information (S501, C31 in FIG. 14). N is an integer of, for example, 2 to 20, and is set in advance in the MFP 1. When the number of uploaded operation information is less than N, the CPU 11 acquires all the uploaded operation information. As described above, when a plurality of operations are received, the browser 62 stores one piece of operation information for each operation. For example, when a click on an icon is received, two consecutive pieces of operation information are stored. Since the MFP 1 collectively acquires a certain number of pieces of operation information, the number of accesses to the cloud storage service 200 does not increase.

The CPU 11 processes the downloaded operation information in chronological order, based on the operation number or the time stamp. The CPU 11 first analyzes first piece of operation information (S511), and determines whether the operation is a start instruction of a maintenance mode (S512). If it is determined that the operation is not the start instruction of the maintenance mode (S512: NO), the CPU 11 executes a process according to the operation information (S514, C32 in FIG. 14). By processing the downloaded operation information in chronological order, the MFP 1 can execute a process according to a procedure operated by the PC 5.

As described above, the MFP 1 can display a screen including one or more icon images on the touch panel 131 in a state where the remote operation is not provided. When the MFP 1 receives an operation in an area of a currently displayed icon image, the MFP 1 can execute a process indicated by the icon image. In a state where the remote operation is not provided, the MFP 1 executes the instructed image process if the icon image for which the operation is received is an image of an icon indicating an instruction to execute the image process. The MFP 1 changes a currently displayed screen on the touch panel 131 in a case where an event as a trigger for changing the currently displayed screen on the touch panel 131 occurs in a state where the remote operation is not provided.

When the operation information downloaded in S501 is information indicating an operation on the panel image 531, the CPU 11 executes a process corresponding to the operation in S514 as in a case where an operation on the touch panel 131 is received in a state where a remote operation is not provided. Specifically, the CPU 11 reads out the bitmap data stored in the memory 12 in S203 of the image storage process illustrated in FIG. 10, and executes the same process as in a case where an operation on the touch panel 131 is received in a state where a screen based on the data is displayed.

For example, when the operation information is information indicating an operation on the copy icon included in the panel image 531 obtained by virtualization of a standby screen of the MFP 1, the CPU 11 acquires information for displaying the setting screen of the copy process. When the operation information is information indicating an operation related to a setting change on the panel image 531 obtained by virtualization of the setting screen of the copy process, the CPU 11 changes the setting of the copy process. When the operation information is information indicating an operation on an icon indicating an instruction to execute the image forming process, the CPU 11 starts execution of the image forming process as a process corresponding to the operation. For example, when the operation information is information indicating the operation on the icon for instructing the execution of the copy process on the panel image 531 obtained by virtualization of the setting screen of the copy process, execution of the copy process is started.

When the operation information is information indicating a key operation, the CPU 11 executes a process corresponding to the operation as in the case of receiving an operation on the hard keys 132. The CPU 11 updates the image data indicating the screen to be displayed according to the execution of the process, and stores the image data in the memory 12 (S515).

For example, when the information for displaying the setting screen of the copy process is acquired, the CPU 11 changes a screen to be displayed to a setting screen including an icon for instructing a setting change, an input field of a setting value to be changed, an icon for instructing execution of the copy process, and the like. When the information indicating the instruction to change the setting of the copy process is acquired, the CPU 11 sets the screen to be displayed as the setting screen of the copy process updated to indicate the changed setting. After changing the setting of the copy process, the CPU 11 may set the screen to be displayed as the standby screen. After starting the execution of the image forming process, the CPU 11 sets a screen to be displayed as an execution screen of the image forming process, for example, an execution screen of the copy process. When the operation mode is the third mode, the CPU 11 displays the updated screen to be displayed on the touch panel 131. When the operation mode is the first mode or the second mode, the CPU 11 does not change the display of the touch panel 131 and keeps the provision-in-progress screen 91 illustrated in FIG. 11.

On the other hand, if it is determined that the operation is the start instruction of the maintenance mode (S512: YES), the CPU 11 starts the maintenance mode (S516). The maintenance mode is, for example, a mode performed by a maintenance person for maintenance of the MFP 1, and is, for example, a mode in which a print instruction of a report or an operation status confirmation instruction can be received. The MFP 1 can receive the start instruction of the maintenance mode by, for example, a combination of specific operations on a specific key.

Upon receiving the start instruction of the maintenance mode, the CPU 11 sets a screen to be displayed as a dedicated maintenance mode screen, which is a screen for receiving an instruction executable in the maintenance mode. The CPU 11 sets the maintenance mode screen as a screen to be displayed and stores, in the memory 12, data indicating the screen to be displayed (S517). The CPU 11 calculates a checksum of the maintenance mode screen, which is a screen to be displayed, and stores the checksum in the memory 12 (S518). When the operation mode is the third mode, the CPU 11 displays the maintenance mode screen on the touch panel 131.

In the state where neither the cloud remote operation nor the local remote operation is being provided, the MFP 1 displays a maintenance mode screen on the touch panel 131 in the maintenance mode. Further, in the maintenance mode, for example, the MFP 1 can receive only an execution instruction of the maintenance mode in which a type of the maintenance mode is specified by a number. In the maintenance mode, the MFP 1 does not receive a print instruction from an external device, for example. Screen data of the maintenance mode screen is, for example, bitmap data, and the screen ID is not set. Therefore, the CPU 11 uses a checksum for determining whether the screen is changed.

The screen ID may also be set on the maintenance mode screen. In this case, instead of calculating the checksum, the MFP 1 may store the screen ID in S518. In addition to the maintenance mode screen, a screen whose screen ID is not set may be provided. In this case, when a screen whose screen ID is not set is displayed, the MFP 1 may also calculate and store a checksum.

After S515 or S518, the CPU 11 deletes the processed operation information from the structured storage 202 (S521). Then, the CPU 11 determines whether the N pieces of operation information acquired in S511 have been processed (S522). If it is determined that the N pieces of operation information has not been processed (S522: NO), the CPU 11 proceeds to S511 and processes the next one piece of operation information. If it is determined that all of the N pieces of operation information have been processed (S522: YES), the CPU 11 ends the operation information process and returns to the device image changing process in FIG. 16. Instead of deleting the N pieces of operation information one by one in S521, the CPU 11 may collectively delete the N pieces of operation information after the N pieces of operation information have been processed (YES in S522).

Returning to the description of the device image changing process in FIG. 16. After the operation information process of S411, the CPU 11 executes the image storage process (S431). The image storage process is a process illustrated in FIG. 10, and is a process of uploading, to the cloud storage service 200, panel image data indicating the current displayed panel image.

By the image storage process, as illustrated in C33 to C35 in FIG. 14, the panel image data is uploaded to the structured storage 202 or the non-structured storage 201, and the image information is uploaded to the structured storage 202. C33 to C35 in FIG. 14 are the same processes as B13 to B15 in FIG. 8. The information uploaded in C33 to C35 is downloaded by the browser 62 in C21 to C23 as described above, and is processed by the browser 62.

For example, when the process is executed based on the acquired operation information, the MFP 1 may change the screen to be displayed. In the operation information process in S411, for example, when the screen to be displayed is updated (S515) or when the maintenance mode is started and the screen to be displayed becomes the maintenance mode screen (S517), the MFP 1 executes the image storage process to upload the panel image data indicating the updated screen to be displayed and the image information.

As a result, after uploading the operation information indicating the operation on the panel image 531, the browser 62 can download new panel image data and update and display the panel image 531 in response to the MFP 1 that has executed a process according to the operation information updating the image information. Accordingly, when the screen to be displayed in the MFP 1 is changed, an image indicating the changed screen is displayed on the user IF 53 of the PC 5. After the image storage process of S431, the CPU 11 returns to S401 and determines whether the next confirmation timing has come.

On the other hand, if it is determined that the operation information is not stored (S403: NO), the CPU 11 determines whether the operation mode is the third mode (S421). If it is determined that the operation mode is the third mode (S421: YES), the CPU 11 determines whether the screen to be displayed is changed (S423).

When operating in the third mode, the MFP 1 may cause the touch panel 131 to display a screen including an icon image. The MFP 1 may change the currently displayed screen by receiving the operation on the touch panel 131. The user operation including an instruction to change a currently displayed screen is an example of an event as a trigger for changing a screen to be displayed. In the maintenance mode, the CPU 11 may determine whether the screen to be displayed is changed based on, for example, whether the checksum is changed.

If it is determined that the screen to be displayed has been changed (S423: YES), the CPU 11 stores, in the memory 12, data indicating the changed screen to be displayed (S424), and executes the image storage process (S431). Accordingly, in the third mode, the CPU 11 can change, by the user operation, the screen to be displayed, and can upload panel image data virtually indicating the changed screen to be displayed.

On the other hand, if it is determined that the operation mode is not the third mode (S421: NO), or if it is determined that the screen to be displayed is not changed (S423: NO), the CPU 11 returns to S401 and determines whether the next confirmation timing has come.

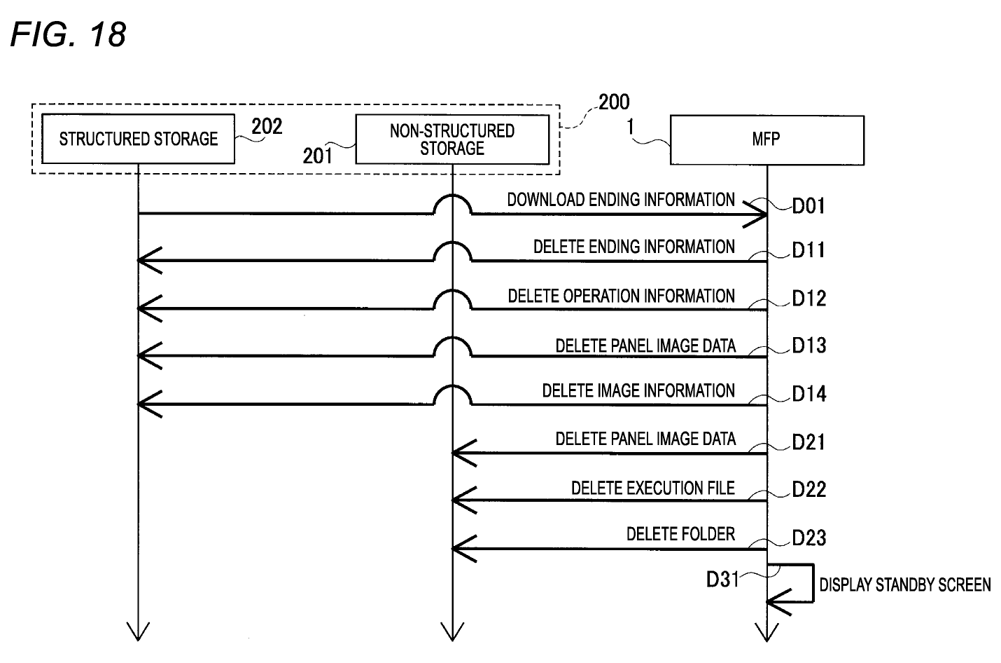

If it is determined that the ending information is uploaded (S402: YES), the CPU 11 executes an operation ending process (S441). Further, the CPU 11 changes the cloud state information 81 (see FIG. 3) to the information indicating "unused" (S442). S402 is an example of an ending condition of the first remote operation, and when the ending information is stored (YES in S402), the CPU 11 determines that the ending condition of the first remote operation is satisfied. When the ending information is uploaded, the CPU 11 does not download the operation information even if the operation information not downloaded is uploaded. A procedure of the operation ending process will be described with reference to a sequence diagram of FIG. 18.

The MFP 1 downloads the ending information from the structured storage 202 (D01). As described above, the ending information is information stored in the structured storage 202 by the browser 62 in C42 of FIG. 14. The ending information includes, for example, as illustrated in the record R51 of FIG. 12, information indicating that the ending instruction is received in C41 of FIG. 14.

By downloading the ending information, the MFP 1 deletes various kinds of information uploaded to the structured storage 202 or the non-structured storage 201. Specifically, the MFP 1 instructs the structured storage 202 to delete the stored ending information of the current cloud remote operation (D11). The MFP 1 instructs the structured storage 202 to delete the operation information of the current cloud remote operation stored (D12). Upon receiving the ending instruction, the MFP 1 deletes all the unprocessed operation information.

Further, the MFP 1 instructs the structured storage 202 to delete the uploaded panel image data and the image information (D13 and D14). If there is panel image data uploaded to the non-structured storage 201, the MFP 1 instructs to delete the panel image data (D21). When the ending instruction is received by the PC 5, various kinds of data uploaded to the structured storage 202 or the non-structured storage 201 are deleted. Therefore, a load on the memory of the structured storage 202 or the non-structured storage 201 can be reduced.

Further, the MFP 1 instructs to delete the execution file 26 uploaded to the non-structured storage 201 at the start of the cloud remote operation (D22). Further, the MFP 1 instructs to delete the folder created in A32 of FIG. 4 (D23). The order of deleting the data is not limited to the above order, and may be any order.

When all the data is deleted, the MFP 1 ends the cloud remote operation. For example, the MFP 1 can display a standby screen on the touch panel 131 (D31) and receive the user operation. The MFP 1 may display on the touch panel 131 that the cloud remote operation has ended.

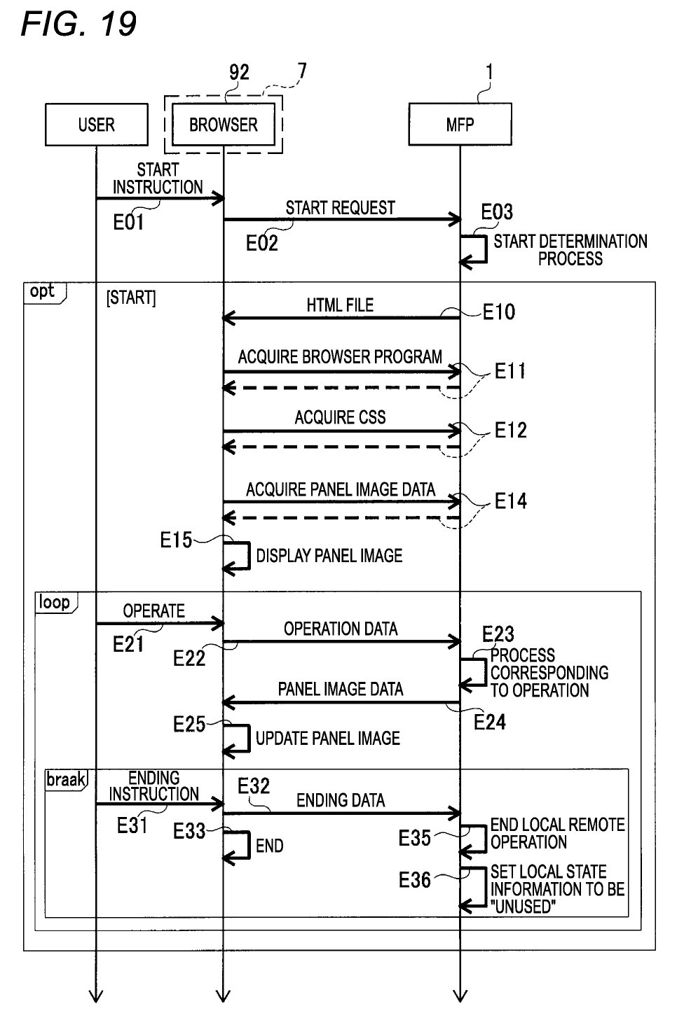

Next, a procedure of the local remote operation will be described. First, a local operation procedure, which is a procedure when a start request for a local remote operation is received in a state where neither a cloud remote operation nor a local remote operation is being provided, will be described with reference to a sequence diagram of FIG. 19.

The user of the PC 7 capable of local communication with the MFP 1 activates the browser 92 in the PC 7, specifies address information indicating the EWS 80 of the MFP 1, and issues a start instruction of the local remote operation (E01). The browser 92 accesses the MFP 1 according to the local communication based on the specified address information, and transmits a start request for the local remote operation (E02).

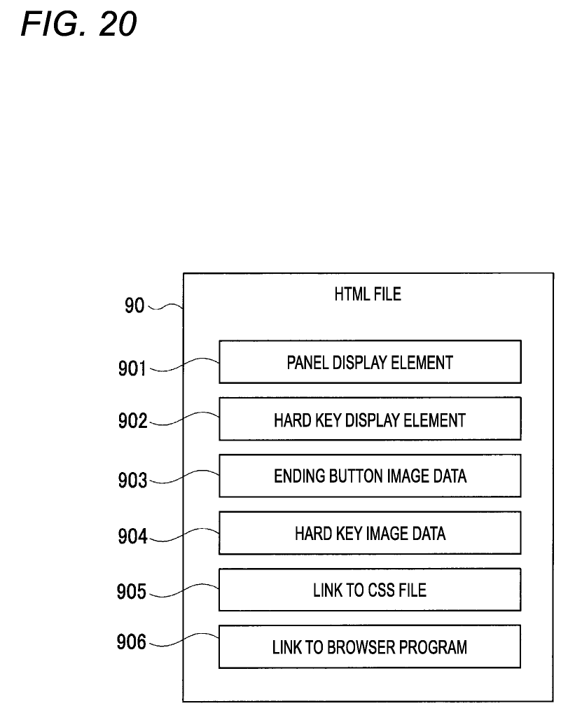

Upon receiving the start request for the local remote operation, the MFP 1 executes the start determination process illustrated in FIG. 6 to determine whether to start the local remote operation (E03). When it is determined to start the local remote operation (opt: [start]), the MFP 1 transmits an HTML file indicating a Web page for the local remote operation to the PC 7 in response to the start request for the local remote operation received in E02 (E10). As illustrated in FIG. 20, the HTML file includes, for example, a panel display element 901, a hard key display element 902, ending button image data 903, hard key image data 904, a link 905 to a CSS file, and a link 906 to a browser program 84 (see FIG. 3). A HTML file 90 is stored in, for example, the memory 12 (see FIG. 1). The MFP 1 may dynamically generate the HTML file 90.

The panel display element 901, the hard key display element 902, and the hard key image data 904 are the same information as the panel display element 266, the hard key display element 267, and the hard key image data 264 (see FIG. 9) included in the execution file 26 used in the cloud remote operation. The data may be exactly the same as or partially different from the information included in the execution file 26.

As described above, when it is determined to start the local remote control in response to the start request for the local remote operation, the MFP 1 sets the local state information 82 as information indicating "in use". In the local remote operation, the MFP 1 can transfer various kinds of information to the browser 92 of the PC 7 via local communication not via the cloud storage service 200. After transmitting the HTML file in E10, the MFP 1 enters a providing state where the local remote operation is being provided until an ending condition for ending the local remote operation is satisfied. The providing state of the local remote operation is an example of a second remote operation providing state.

The browser 92 acquires the browser program 84 and the CSS file from the MFP 1 based on the link described in the acquired HTML file 90 (E11 to E12). The browser program 84 is a program that can be operated by the browser 92, and is a program that is similar to the browser P 262 (see FIG. 9) of the cloud remote operation, and is partially different program. Differences will be described in detail later. The browser program 84 is an example of a second remote operation program.

The CSS file is the same information as the CSS 261 (see FIG. 9) included in the execution file 26 (see FIG. 9) used in the cloud remote operation. The CSS may be exactly the same as or partially different from the CSS 261 included in the execution file 26. For example, the CSS of the local remote operation may indicate a display content in which a display color, a frame shape, and the like of the CSS of the local remote operation are slightly different from those of the CSS of the cloud remote operation.

The HTML file 90 may include a link to the hard key image data instead of the hard key image data 904. In this case, similarly to the browser program 84 and the CSS file (E11 to E12), the browser 92 may acquire the hard key image data 904 from the MFP 1 based on the link.

Instead of the HTML file 90 illustrated in FIG. 20, the MFP 1 may pass the HTML file in which the CSS and the browser program 84 are embedded, to the browser 92, as in the execution file 26 (see FIG. 9) used in the cloud remote operation. Further, the hard key image data may be incorporated into the browser program 84. For the ending button image data, the HTML file may include an ending button display element, and the ending button image data may be incorporated into the browser program 84.

The browser 92 acquires panel image data from the MFP 1 (E14), and displays the panel image on the user IF 93 (see FIG. 3) of the PC 7 based on the acquired panel image data (E15). The panel image data acquired from the MFP 1 in E14 is data for virtually reproducing the screen to be displayed on the touch panel 131 of the MFP 1, and is, for example, bitmap data or PNG data obtained by compressing bitmap data. E14 is an example of an image transmission process, and panel image data transmitted by the MFP 1 in E14 is an example of second image data. E15 is an example of a local screen display process, and the panel image displayed on the user IF 93 of the PC 7 in E15 is an example of a second remote operation screen.

Accordingly, a panel image for virtually reproducing the user IF 13 of the MFP 1 is displayed on the user IF 93 of the PC 7 as in the example illustrated in FIG. 13. The panel image displayed on the user IF 93 of the PC 7 also includes an ending button similarly to the panel image 531 displayed on the user IF 53 of the PC 5. As in the case of the cloud remote operation, the MFP 1 may transmit panel image data not including a moving image or an animation in E14.

The user who uses the PC 7 can perform an operation on the user IF 93 on which the panel image is displayed (E21). When the browser 92 receives an operation on the currently displayed panel image, if the user operation is not an operation on the ending button, the browser 92 transmits operation data indicating the operation content to the MFP 1 via the local communication (E22). The operation data transmitted in E22 is an example of second operation data, and E22 is an example of an operation transmission process.

When the local remote operation is provided as the primary remote operation, the MFP 1 determines the screen to be displayed on the touch panel 131 according to the operation mode. That is, when the operation mode is the first mode or the second mode, the MFP 1 causes the touch panel 131 to display the provision-in-progress screen 91 (see FIG. 11). When the operation mode is the third mode, the MFP 1 causes the touch panel 131 to display the screen to be displayed.

The MFP 1 executes a process corresponding to the operation content based on the received operation data (E23). When the screen to be displayed on the touch panel 131 is updated by the process of E23, the MFP 1 transmits panel image data indicating the updated screen to the PC 7 (E24). E24 is an example of the image transmission process. The browser 92 of the PC 7 updates the panel image based on the received panel image data (E25). The browser 92 repeats E21 to E25 each time the user operation is received (loop).

When the operation on the ending button is received (E31), the browser 92 stops the repetition of E21 to E25 (break), and transmits ending data indicating the ending instruction to the MFP 1 (E32). The PC 7 ends the local remote operation (E33). The PC 7 may end the browser 92.

Upon receiving the ending data, the MFP 1 ends the provision of the local remote operation (E35). The MFP 1 may display, for example, the end of the local remote operation. Upon receiving the ending data of the local remote operation from the PC that is providing the local remote operation, the MFP 1 determines that the ending condition of the second remote operation is satisfied. The MFP 1 ends the local remote operation and changes the local state information 82 to the information indicating "unused" (E36). Accordingly, the provision of the local remote operation is ended, and the MFP 1 displays, for example, a home screen on the touch panel 131.

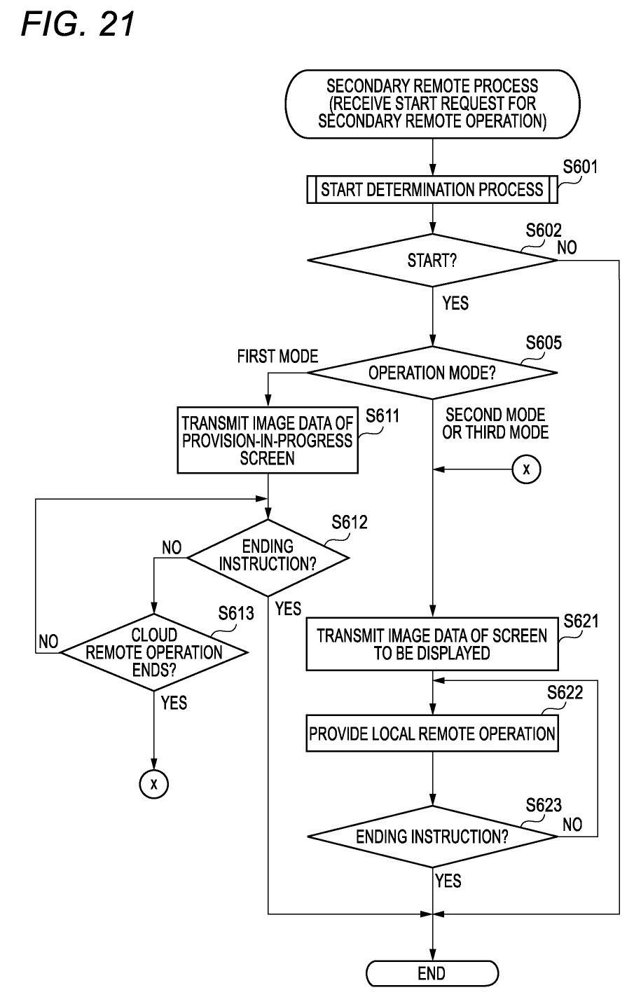

Next, a procedure of a secondary remote process, which is a process executed in MFP 1 when a start request for the other remote operation is received while either the cloud remote operation or the local remote operation is being provided, will be described with reference to a flowchart in FIG. 21. As described above, even when the MFP 1 receives the start instruction of the cloud remote operation from another PC while the cloud remote operation is being provided, the MFP 1 does not start the cloud remote operation by another PC. Further, even when the MFP 1 receives the start instruction of the local remote operation from another PC while the local remote operation is being provided, the MFP 1 does not start the local remote operation by another PC. On the other hand, the MFP 1 can start providing the other remote operation while providing one remote operation.

Hereinafter, a process in a case where the start request for the local remote operation is received from the PC 7 while a cloud remote operation is being provided to the PC 5 will be described. Upon receiving the start request for the local remote operation, the CPU 11 first executes the start determination process illustrated in FIG. 6 (S601). Then, the CPU 11 determines whether it is determined to start in the start determination process (S602).

When it is determined to start the local remote operation (S602: YES), the CPU 11 determines whether the operation mode is the first mode, the second mode, or the third mode (S605). Prior to the start of the secondary remote process, when the provision of the cloud remote operation is started, the CPU 11 changes a screen displayed on the touch panel 131 according to the operation mode in S204 of the image storage process (FIG. 10) executed in the screen preparation procedure (A35, FIG. 8). Specifically, in the first mode or the second mode, the CPU 11 displays the provision-in-progress screen 91 (FIG. 11) on the touch panel 131. In the third mode, the CPU 11 displays the screen to be displayed on the touch panel 131.

If it is determined that the operation mode is the first mode (S605: first mode), the CPU 11 transmits, to the PC 7 that performs the local remote operation, image data indicating the same screen configuration as the currently displayed provision-in-progress screen 91 on the touch panel 131 (S611). S611 is an example of a remote operation in-progress screen display process. The image data transmitted to the PC 7 in S611 is an example of third image data. That is, when the provision of the local remote operation is started as the secondary remote operation in the first mode, the CPU 11 transmits the panel image data indicating the provision-in-progress screen 91, which is a currently displayed screen on the touch panel 131, in E14 of the local operation procedure illustrated in FIG. 19.

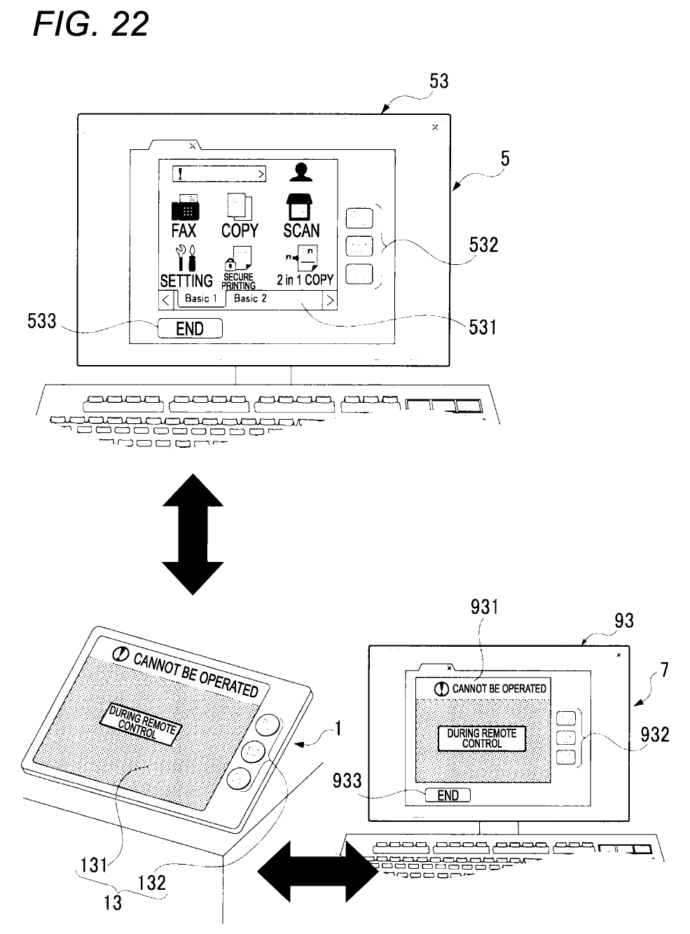

Accordingly, the browser 92 of the PC 7 displays the same screen as the provision-in-progress screen 91 on the user IF 93 in E15 of the local operation procedure. Therefore, for example, as illustrated in FIG. 22, a panel image including various icons capable of receiving an operation by the user is displayed on the user IF 53 of the PC 5, and a panel image including the provision-in-progress screen 91 is displayed on the touch panel 131 of the MFP 1 and the user IF 93 of the PC 7. As described above, the provision-in-progress screen 91 is a screen that does not include an operator such as an icon or at least an operator related to image formation.

After transmitting, to the PC 7, the panel image data indicating the same screen configuration as the provision-in-progress screen 91, the CPU 11 determines whether an ending instruction is received from the PC 7 (S612). For example, as illustrated in FIG. 22, an ending button 933 may be displayed on the user IF 93 of the PC 7 in addition to the provision-in-progress screen 91. When an operation on the ending button 933 is received, the PC 7 transmits ending data indicating the instruction to the MFP 1 (E32 in FIG. 19).

If it is determined that the ending instruction has not been received (S612: NO), the CPU 11 determines whether the cloud remote operation, which is the primary remote operation, has ended (S613). If it is determined that the cloud remote operation has not ended (S613: NO), the CPU 11 waits until an ending instruction of the local remote operation is received or the cloud remote operation ends. When it is determined that the cloud remote operation has ended (S613: YES), the CPU 11 proceeds to S621 to be described later, and continues to provide the local remote operation.

When operating in the first mode, the MFP 1 may transmit data indicating a screen not including the ending button 933 to the PC 7 that performs the local remote operation as the secondary remote operation. In this case, the user of the PC 7 can immediately start the local remote operation when the cloud remote operation ends. On the other hand, by transmitting the data indicating the screen including the ending button 933, the user of the PC 7 can immediately end the local remote operation for which the start request has been transmitted.

In the first mode, even when the provision of the local remote operation is started as the secondary remote operation, the user of the PC 7 cannot remotely operate the MFP 1. Therefore, in the first mode, the MFP 1 may not start providing the secondary remote operation even when receiving a start instruction of the secondary remote operation. That is, even when it is determined to start in the start determination process of S601, the CPU 11 may transmit a response not to be provided in response to the start instruction of the secondary remote operation when operating in the first mode.

For example, as illustrated in FIG. 22, a key image 932 may also be displayed on the user IF 93 of the PC 7 that performs the secondary remote operation in the first mode. However, even when an operation on the key image 932 is received, the PC 7 may not transmit information on the operation to the MFP 1. For example, when the provision of the local remote operation is started as the secondary remote operation in the first mode, a browser program transmitted to the PC 7 in E11 may be a program partially different from that in the case of the primary remote operation. Alternatively, the MFP 1 may not execute a process (E23) corresponding to the operation (E22) even when receiving the operation data from a device that is providing the secondary remote operation in the first mode.

On the other hand, when it is determined that the operation mode is the second mode or the third mode (S605: second mode or third mode), the CPU 11 transmits, to the PC 7, the image data of the screen to be displayed (S621). The CPU 11 starts providing the local remote operation to the PC 7 (S622).

When the provision of the local remote operation to the PC 7 is started, the MFP 1 executes a process based on the operation data transmitted from the PC 7 according to the procedure of FIG. 19 described above. That is, the user of the PC 7 can remotely control the MFP 1 via the local communication. In this case, the MFP 1 can receive both operation data from the PC 5 that performs the primary remote operation and operation data from the PC 7 that performs the secondary remote operation, and can execute a process based on the received data.

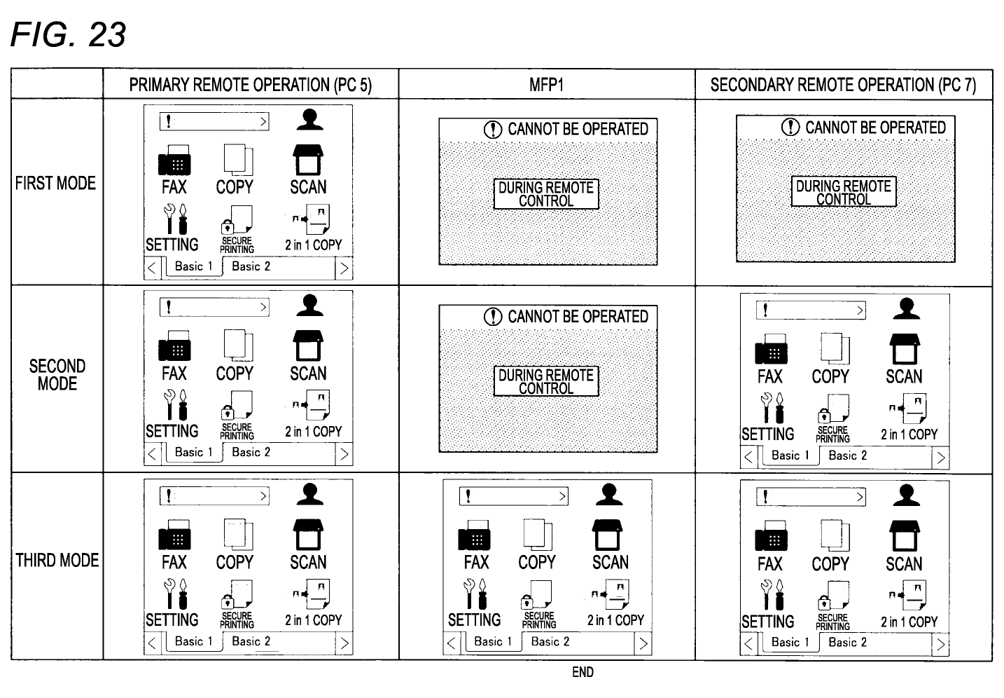

FIG. 23 illustrates an example of a screen displayed on each device according to the operation mode when the primary remote operation and the secondary remote operation are provided in parallel. In the first mode, an operation screen capable of receiving an operation by the user is displayed on the PC 5 that performs the primary remote operation, and a screen incapable of receiving an operation by the user is displayed on the MFP 1 and the PC 7 that performs the secondary remote operation. In the second mode, an operation screen capable of receiving an operation by the user is displayed on the PC 5 and the PC 7, and a screen incapable of receiving an operation by the user is displayed on the MFP 1. In the third mode, an operation screen capable of receiving an operation by the user is displayed on each of the PC 5, the PC 7, and the MFP 1.

When the MFP 1 displays a screen that cannot receive an operation by the user, the MFP 1 may disable detection of the operation on the touch panel 131 instead of displaying the provision-in-progress screen 91. In this case, for example, the MFP 1 may turn off the backlight of the touch panel 131 to make the screen invisible, may display a screen to be displayed or a screen subjected to processing such as making the screen to be displayed monochrome, or may fix and display a predetermined screen such as a standby screen or a home screen. If the screen is made invisible or a fixed screen is displayed, the user of the MFP 1 can recognize that the operation on the touch panel 131 cannot be performed. When the screen to be displayed is displayed, the user of the MFP 1 can grasp the operation content by the remote operation.

If it is determined that the cloud remote operation of the primary remote operation has ended in the first mode (S613: YES), the CPU 11 proceeds to S621 and transmits, to the PC 7, the image data of the screen to be displayed. The CPU 11 transmits, for example, data indicating a home screen displayed after the cloud remote operation is ended. Further, the MFP 1 provides a local remote operation to the PC 7 (S622). In this case, since the local remote operation is the primary remote operation, the MFP 1 executes a process based on the operation data received from the PC 7 according to the local operation procedure illustrated in FIG. 19 (loop in E21 to E25).

The CPU 11 determines whether the ending instruction of the local remote operation has been received (S623). When the ending data is received from the PC 7, the CPU 11 determines that the ending instruction of the local remote operation is received. If it is determined that the ending instruction has been received (S612: YES or S623: YES), the CPU 11 ends the provision of the local remote operation to the PC 7 and ends the secondary remote process. When the ending instruction of the cloud remote operation has not been received, the MFP 1 can continuously provide the cloud remote operation.

When it is determined not to start the local remote operation in the start determination process (S602: NO), the CPU 11 ends the secondary remote process. For example, if the cloud remote operation and the local remote operation are already being provided, the MFP 1 does not provide a new remote operation in response to information indicating that the new remote operation cannot be started even if the MFP 1 receives the start request for the new remote operation.

Although a case where there are three types of operation modes has been described above, there may be two types of operation modes. For example, the operation mode may be the first mode or the second mode, and the third mode may not be selected. In this case, when the provision of the remote operation is started, the provision-in-progress screen 91 is displayed on the touch panel 131 of the MFP 1. As illustrated in the first mode or the second mode in FIG. 23, the screen displayed on the user IF of a device that performs the secondary remote operation is different depending on the operation mode.

Further, the operation mode may be two types of the first mode and the third mode. In this case, when the provision of the remote operation is started, a different screen is displayed on the touch panel 131 of the MFP 1 depending on the operation mode. A screen similar to the touch panel 131 of the MFP 1 is displayed on the device that performs the secondary remote operation.

Further, the operation mode may be two types of the second mode and the third mode. In this case, when the provision of the remote operation is started, a different screen is displayed on the touch panel 131 of the MFP 1 depending on the operation mode. A screen to be displayed is displayed on both a device that performs the primary remote operation and the device that performs the secondary remote operation.

As described above in detail, according to the remote operation system 100 in the present embodiment, when the provision of the cloud remote operation is started, the MFP 1 can display the provision-in-progress screen 91 on the touch panel 131. While the provision-in-progress screen 91 is currently displayed, the MFP 1 does not receive the operation on the touch panel 131. Accordingly, the execution of the process related to the image formation based on the operation on the touch panel 131 of the MFP 1 is prevented. Therefore, the operation of MFP 1 not intended by the user of PC 5 that performs the cloud remote operation is avoided. For example, in a case where the provision of the local remote operation is started as the secondary remote operation in a state in which the cloud remote operation is provided as a primary remote operation, the MFP 1 can also display a screen similar to the provision-in-progress screen 91 to the user IF 93 of the PC 7 that performs the local remote operation. When a screen similar to the provision-in-progress screen 91 is displayed, the MFP 1 does not execute a process based on the operation data from the PC 7. Therefore, the operation of MFP 1 not intended by the user of the PC 5 that performs the cloud remote operation is avoided by the operation by the user of the PC 7.

Further, according to the remote operation system 100 in the present embodiment, the MFP 1 has three types of operation modes. Depending on the operation mode, the screens to be displayed on the respective devices are different, and whether the operation on the screen is allowed to be received is different. In the first mode, the operation can be performed only by the PC 5 that performs the cloud remote operation as the primary remote operation. In the second mode, the PC 5 that performs the cloud remote operation as the primary remote operation and the PC 7 that performs the local remote operation as the secondary remote operation can be operated. In the third mode, any of the PC 5 that performs the cloud remote operation, the PC 7 that performs the local remote operation, and the MFP 1 can be operated. Therefore, a preferred application can be achieved according to the usage form of the remote operation system 100.

In many cases, communication between different networks has a problem in safety, and communication is often restricted. Therefore, the PC 5 may not directly transfer data necessary for remote operation to the MFP 1 which is not in the same network. As in the present invention, by transferring data between the PC 5 and the MFP 1 using the cloud storage service 200 on the Internet, the communication is less likely to be restricted, and there is a higher possibility that the remote operation for the MFP 1 not in the same network can be realized.

The present embodiment is merely an example, and does not limit the present invention. Therefore, various improvements and modifications can be naturally made to the technique disclosed in the present specification without departing from the gist of the present invention. For example, a device to be subjected to the local remote operation or the cloud remote operation may be a device having a communication IF and connectable to the Internet and having an image processing function. The device is not limited to an MFP, and may also be a single-function printer, a copy device, a scanner, a FAX device, or a machine tool capable of executing a machining process based on an image. The device that performs the local remote operation or the cloud remote operation is not limited to a PC, and may be a mobile terminal such as a smartphone or a tablet computer. Furthermore, the remote operation system 100 may include one or more devices that perform a remote operation and one or more devices that are subjected to the remote operation, and the number and arrangement of these devices are not limited to the illustrated example.

A configuration of the user IF 13 of the MFP 1 is not limited to a configuration illustrated in the embodiment. For example, the MFP 1 may have a screen having only a display function instead of the touch panel 131, and may be configured to receive an operation input by a cursor operation or the like. The number of hard keys 132 is not limited to three, or may be zero.

For example, the MFP 1 may receive a local remote operation from the same PC as a PC that executes a cloud remote operation. For example, a PC capable of communicating with the MFP 1 via the LAN may receive the start instruction of the cloud remote operation by the start application 63, and may further execute a local remote operation via the EWS 80. In this case, one browser of the PC may display a plurality of web pages to perform both remote operations, or the browsers may be activated in different processes to perform remote operations on the browsers. In this case, the PC is an example of a first information processing device or an example of a second information processing device.

For example, in the embodiment, when the start request for the remote operation is received, the use permission confirmation screen 71 is displayed to obtain the approval of the user, but this procedure may be omitted, and the subsequent process may be executed as in a case where the approval is obtained. For example, when the start instruction of another remote operation is received after the start instruction of the cloud remote operation or the local remote operation is received and rejected by the user, the remote operation is not provided without displaying the use permission confirmation screen 71, and the MFP 1 may display the use permission confirmation screen 71 again. In this case, when the remote operation is rejected by the user, the MFP 1 does not provide the remote operation received later. On the other hand, when the remote operation is approved by the user, the MFP 1 may start providing the remote operation received later.

For example, when the selection state information 83 is information indicating "rejected", the MFP 1 may or may not automatically change the selection state information 83 to "approved" after a predetermined period. For example, the MFP 1 may continue storing the information indicating "rejected" until the power is turned off, or may delete the information according to the user operation. A deletion procedure may be different between a case where the cloud remote operation is rejected and a case where the local remote operation is rejected.

In the embodiment, when the cloud remote operation is provided, the PC 5 uploads the record including the instruction data to the structured storage 202, the MFP 1 acquires the instruction data by downloading the instruction data, but the present invention is not limited thereto. For example, the PC 5 may directly transmit the instruction data to the MFP 1. The MFP 1 may directly transmit the response data to the PC 5.

In the embodiment, when a cloud remote operation is provided, the MFP 1 uploads the response data including the host folder access information 243 to the structured storage 202, thereby passing the URL to the PC 5, but the present invention is not limited thereto. For example, the start application 63 of the PC 5 may hold in advance a URL indicating a folder used by the MFP to be subjected to the cloud remote operation.

In the embodiment, when the cloud remote operation is provided, the image information includes information indicating the structured storage 202 or the non-structured storage 201 as information indicating the storage location of the panel image data, but the present invention is not limited thereto. For example, the information indicating the storage location may be information included only when the panel image data is uploaded to the structured storage 202, or may be information included only when the panel image data is uploaded to the non-structured storage 201.

The provision-in-progress screen 91 is a screen that does not include an operator, and may be a screen that does not include at least a specific operator that is an operator related to image formation. For example, if there is not an operator related to image formation but an operator that does not serve as a trigger for changing the screen to be displayed even when an operation is received, the provision-in-progress screen 91 may be a screen including the operator.

In the embodiment, a case where the cloud remote operation is provided as the primary remote operation and the start instruction of the local remote operation is received as the secondary remote operation has been described, and the MFP 1 can receive the start instruction of the cloud remote operation from PC 5 or the like during the provision of the local remote operation. In this case, similarly to the secondary remote process illustrated in FIG. 21, the MFP 1 may determine a screen to be displayed on each device according to the operation mode. Further, in the first mode, the MFP 1 transmits, to the device that performs the secondary remote operation, data indicating the same screen as the currently displayed screen on the touch panel 131. The screen may not receive the user operation, and may not be the same as the currently displayed screen on the touch panel 131.

Further, in the embodiment, although it has been described that an operation on the ending button 533 (see FIG. 13) displayed on the PC or the like is received as a trigger to end the local remote operation or the cloud remote operation, the present disclosure is not limited thereto. For example, when the PC 5 or the PC 7 is executing the remote operation and does not receive the operation on the browser 62 for a predetermined period, the PC 5 or the PC 7 may upload or transmit the ending information and end the remote operation as in the case of receiving the ending instruction. For example, when the MFP 1 receives a specific operation, for example, when the MFP 1 receives a long press of a cancel button, the remote operation may be ended. Further, when new operation information is not uploaded for a predetermined time, the MFP 1 may determine that the ending instruction is received. In this case, the MFP 1 may upload the information indicating the ending instruction to the structured storage 202.

In the embodiment, although an example has been described in which one token is acquired for each of the non-structured storage 201 and the structured storage 202, a plurality of tokens may be acquired for one area. In this case, for example, a plurality of tokens may be stored as the access information 24 of the MFP 1, and one of tokens may be used by itself and the other may be passed to the PC 5. For example, different tokens may be used for uploading and downloading. Different tokens may be used for MFPs.

In any flowchart or sequence diagram disclosed in the embodiment, an execution order of a plurality of processes in any plurality of steps can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

What is claimed is:

1. A system comprising an image forming device, a first information processing device, and a second information processing device,
wherein the first information processing device, the second information processing device, and the image forming device are connected to the Internet,
the image forming device includes a display, and the image forming device is configured to cause the display to display a main body operation screen including a plurality of operators,
the image forming device is configured to execute an image upload process of uploading, to the cloud storage, first image data indicating a first remote operation screen, the first remote operation screen being a screen for virtually reproducing the main body operation screen displayed on the display,
the first information processing device is configured to execute a screen display process of downloading the first image data from the cloud storage to cause a user interface of the first information processing device to display the first remote operation screen indicated by the first image data,
the first information processing device is configured to execute an operation upload process of uploading, to the cloud storage, first operation data indicating an operation content, in a case where an operation on the first remote operation screen is received via the user interface of the first information processing device,
the image forming device is configured to download the first operation data from the cloud storage to execute a process corresponding to an operation indicated by the first operation data,
the image forming device is configured to execute an image transmission process of transmitting, to the second information processing device, second image data indicating a second remote operation screen, not via the cloud storage, the second remote operation screen being a screen for virtually reproducing the main body operation screen displayed on the display,
the second information processing device is configured to execute a local screen display process of causing a user interface of the second information processing device to display the second remote operation screen indicated by the received second image data,
the second information processing device is configured to execute an operation transmission process of transmitting, to the image forming device, second operation data indicating an operation content, not via the cloud storage, in a case where an operation on the second remote operation screen is received via the user interface of the second information processing device,
the image forming device is configured to execute a process corresponding to an operation indicated by the received second operation data, in a case where the image forming device receives the second operation data from the second information processing device,
in a case where the image forming device starts the provision of the first remote operation after receiving the start instruction of the first remote operation, the image forming device is configured to enter a first remote operation providing state until an ending condition of the first remote operation is satisfied,
in a case where the image forming device enters the first remote operation providing state, the image forming device is configured not to cause the display to display the main body operation screen, and
in a case where the image forming device does not enter the first remote operation providing state, the image forming device is configured to cause the display to display the main body operation screen.

2. The system according to claim 1,
wherein the image forming device is configured to change the content of the main body operation screen, in a case where an event as a trigger for changing the main body operation screen occurs in a state where the image forming device is not in the first remote operation providing state,
the image forming device is configured to execute the image upload process in a case where an event as a trigger for changing the main body operation screen occurs in a state where the image forming device is in the first remote operation providing state, and in the image upload process, the image forming device is configured to upload, to the cloud storage, the first image data for virtually reproducing the changed main body operation screen, and
the first information processing device is configured to execute the screen display process, in a case where the first image data for virtually reproducing the changed main body operation screen is uploaded to the cloud storage, and in the screen display process, the first information processing device is configured to download, from the cloud storage, the first image data for virtually reproducing the changed main body operation screen to cause the user interface of the first information processing device to display the first remote operation screen for virtually reproducing the changed main body operation screen.

3. The system according to claim 1,
wherein the image forming device is configured to change the content of the main body operation screen, in a case where an event as a trigger for changing the main body operation screen occurs in a state where the image forming device is not in the first remote operation providing state,
in a case where an event as a trigger for changing the main body operation screen occurs according to execution of the process corresponding to the operation indicated by the first operation data in a state where the image forming device is in the first remote operation providing state, the image forming device is configured to execute the image upload process to upload, to the cloud storage, the first image data for virtually reproducing the changed main body operation screen according to the process corresponding to the operation indicated by the first operation data, and
the first information processing device is configured to execute the screen display process, in a case where the first image data for virtually reproducing the changed main body operation screen according to the process corresponding to the operation indicated by the first operation data is uploaded to the cloud storage, and
in the screen display process, the first information processing device is configured to download, from the cloud storage, the first image data for virtually reproducing the changed main body operation screen according to the process corresponding to the operation indicated by the first operation data, and configured to cause the user interface of the first information processing device to display the first remote operation screen for virtually reproducing the changed main body operation screen according to the process corresponding to the operation indicated by the first operation data.

4. The system according to claim 1,
wherein the image forming device includes a touch panel as the display, the image forming device is configured to cause the touch panel to display a main body operation screen including the plurality of operators, and in a case where an operation on one of the plurality of operators is received, the image forming device is configured to execute a process based on the operator having received the operation,
the first information processing device is configured to execute the screen display process, and in the screen display process, the first information processing device is configured to cause the user interface of the first information processing device to display the first remote operation screen for virtually reproducing the main body operation screen based on the first image data downloaded from the cloud storage, and
the first information processing device is configured to execute the operation upload process, in a case where an operation on one of the plurality of operators displayed on the first remote operation screen is received via the user interface of the first information processing device, and in the operation upload process, the first information processing device is configured to upload, to the cloud storage, information for specifying the operator having received the operation, as the first operation data, and
in a case where the first operation data is uploaded to the cloud storage, the image forming device is configured to download the first operation data from the cloud storage and to execute a process based on the operator specified by the first operation data.

5. The system according to claim 1,
wherein the image forming device includes an operation panel including a touch panel as the display, the operation panel further includes a plurality of hardware keys, and in a case where the image forming device receives an operation on one of the plurality of hardware keys, the image forming device is configured to execute a process based on the hardware key having received the operation,
the first information processing device is configured to execute the screen display process, and in the screen display process, the first information processing device is configured to cause the user interface of the first information processing device to display the first remote operation screen for virtually reproducing the operation panel based on the first image data downloaded from the cloud storage,
the first information processing device is configured to execute the operation upload process, in a case where an operation on one of the plurality of hardware keys displayed on the first remote operation screen is received via the user interface of the first information processing device, and in the operation upload process, the first information processing device is configured to upload, to the cloud storage, information for specifying the hardware key having received the operation, as the operation data, and
in a case where the first operation data is uploaded to the cloud storage, the image forming device is configured to download the first operation data from the cloud storage and execute a process based on the hardware key specified by the first operation data.

6. The system according to claim 1,
wherein, in a case where the image forming device receives the start instruction of the second remote operation from the second information processing device in a state where the image forming device is in the first remote operation providing state, the image forming device is configured not to transmit the second image data and is configured to transmit, to the second information processing device, third image data indicating a screen for virtually reproducing the remote operation in-progress screen displayed on the display, and
the second information processing device is configured to execute a remote operation in-progress screen display process of causing the user interface of the second information processing device to display the remote operation in-progress screen indicated by the received third image data.

7. The system according to claim 1,
wherein the image forming device is configured to change the content of the main body operation screen in a case where an event as a trigger for changing the main body operation screen occurs in a state where the image forming device is not in the first remote operation providing state,
in a case where the image forming device enters the first remote operation providing state, the image forming device is configured not to change the content of the main body operation screen in a case where an event as a trigger for changing the main body operation screen occurs to disable an operation on the main body operation screen,
in a case where the image forming device does not enter the first remote operation providing state, the image forming device is configured to change the content of the main body operation screen in the case where the event as a trigger for changing the main body operation screen occurs,
in a case where the image forming device receives the start instruction of the second remote operation from the second information processing device in a state where the image forming device is in the first remote operation providing state, the image forming device is configured not to transmit the second image data and is configured to transmit, to the second information processing device, third image data indicating a screen for virtually reproducing a remote operation in-progress screen, the remote operation in-progress screen being a screen not including the specific operator related to image formation, and
the second information processing device is configured to execute a remote operation in-progress screen display process of causing the user interface of the second information processing device to display the remote operation in-progress screen indicated by the received third image data.

8. An image forming device to be connected to the Internet,
wherein the image forming device includes a display, and the image forming device is configured to cause the display to display a main body operation screen including a plurality of operators,
the image forming device is configured to execute an image upload process of uploading, to a cloud storage connected to the Internet, first image data indicating a first remote operation screen, after receiving a start instruction of a first remote operation from a first information processing device via the cloud storage, the first remote operation screen being a screen for virtually reproducing the main body operation screen displayed on the display,
the image forming device is configured to download the first operation data from the cloud storage and execute a process corresponding to an operation indicated by the first operation data, the first operation data being data indicating an operation content on the first remote operation screen,
the image forming device is configured to execute an image transmission process of transmitting, to a second information processing device, second image data indicating a second remote operation screen not via the cloud storage, after receiving a start instruction of a second remote operation from the second information processing device by local communication not via the cloud storage, the second remote operation screen being a screen for virtually reproducing the main body operation screen displayed on the display,
in a case where the image forming device receives second operation data from the second information processing device, the image forming device is configured to execute a process corresponding to an operation indicated by the received second operation data, the second operation data being data indicating an operation content on the second remote operation screen,
in a case where the image forming device starts the provision of the first remote operation after receiving the start instruction of the first remote operation, the image forming device is configured to enter a first remote operation providing state until an ending condition of the first remote operation is satisfied,
in a case where the image forming device enters the first remote operation providing state, the image forming device is configured not to cause the display to display the main body operation screen, and
in a case where the image forming device does not enter the first remote operation providing state, the image forming device is configured to cause the display to display the main body operation screen.

9. The image forming device according to claim 8,
wherein the image forming device includes a touch panel as the display, and the image forming device is configured to cause the touch display to display a main body operation screen including the plurality of operators,
in a case where the image forming device receives an operation on one of the plurality of operators, the image forming device is configured to execute a process based on the operator having received the operation, and in the image upload process, the image forming device is configured to upload, to the cloud storage, image data for virtually reproducing the main body operation screen displayed on the touch panel, as the first image data indicating the first remote operation screen, and
in a case where the first operation data is uploaded to the cloud storage, the image forming device is configured to download the first operation data from the cloud storage and execute a process based on the operator specified by the first operation data.

10. The image forming device according to claim 8,
wherein the image forming device is configured not to start providing the first remote operation, in a case where the start instruction of the first remote operation is received from an information processing device different from the first information processing device in a state where the image forming device is in the first remote operation providing state.

11. The image forming device according to claim 8,
wherein in a case where the image forming device starts providing the second remote operation after receiving the start instruction of the second remote operation, the image forming device is configured to enter a second remote operation providing state until an ending condition of the second remote operation is satisfied, and
in a case where the image forming device receives the start instruction of the second remote operation from another information processing device different from the second information processing device in a state where the image forming device is in the second remote operation providing state, the image forming device is configured not to start providing the second remote operation to the other information processing device.

12. The image forming device according to claim 8,
wherein the image forming device is configured to be switched between a first mode and a second mode, and
in a case where the image forming device receives the start instruction of the second remote operation from the second information processing device in a state where the image forming device is in the first remote operation providing state, the image forming device is configured to transmit:
the third image data to the second information processing device without transmitting the second image data, in a case where the image forming device is in the first mode; and
to the second information processing device, image data for reproducing a screen having a configuration equivalent to that of the first remote operation screen as the second image data indicating the second remote operation screen, in a case where the image forming device is in the second mode.

13. The image forming device according to claim 8,
wherein the image forming device is configured to be switched between the first mode, the second mode, and a third mode,
in a case where the image forming device starts the provision of the first remote operation after receiving the start instruction of the first remote operation, the image forming device is configured to enter the first remote operation providing state until the ending condition of the first remote operation is satisfied,
in a case where the image forming device enters the first remote operation providing state in a state where the image forming device is in the first mode or the second mode, the image forming device is configured to cause the display to display the remote operation in-progress screen without displaying the main body operation screen,
in a case where the image forming device is not in the first remote operation providing state, the image forming device is configured to cause the display to display the main body operation screen,
in a case where the image forming device is in the third mode, the image forming device is configured to cause the display to display the main body operation screen in a state where the image forming device is in the first remote operation providing state, and
in a case where the image forming device receives the start instruction of the second remote operation from the second information processing device in a state where the image forming device is in the first remote operation providing state, the image forming device is configured:
in a case where the image forming device is in the first mode, to transmit the third image data to the second information processing device and not to transmit the second image data; and
in a case where the image forming device is in the second mode or the third mode, to transmit image data for reproducing a screen having a configuration equivalent to that of the first remote operation screen to the second information processing device, as the second image data indicating the second remote operation screen.

14. The image forming device according to claim 8,
in a case where the image forming device enters the first remote operation providing state, the image forming device configured to cause the display to display a remote operation in-progress screen and not to display the main body operation screen,
in a case where the image forming device is not in the first remote operation providing state, the image forming device is configured to cause the display to display the main body operation screen, and
the remote operation in-progress screen is a screen that does not include the specific operator related to image formation.

15. The image forming device according to claim 14,
in a case where the image forming device receives the start instruction of the second remote operation from the second information processing device in a state where the image forming device is in the first remote operation providing state, the image forming device is configured not to transmit the second image data and is configured to transmit, to the second information processing device, third image data indicating a screen for virtually reproducing the remote operation in-progress screen displayed on the display,
the second information processing device is configured to receive the third image data, and cause the user interface of the second information processing device to display the remote operation in-progress screen indicated by the third image data.

16. The image forming device according to claim 14,
In a case where the image forming device receives the start instruction of the second remote operation from the second information processing device in a state where the image forming device is in the first remote operation providing state, the image forming device is configured not to start providing the second remote operation.

17. The image forming device according to claim 14,
the image forming device receives the start instruction of the second remote operation from the second information processing device in a state where the image forming device is in the first remote operation providing state, the image forming device is configured to transmit, to the second information processing device, image data for reproducing a screen having a configuration equivalent to that of the first remote operation screen, as the second image data indicating the second remote operation screen.

18. The image forming device according to claim 14,
in a case where the image forming device enters the first remote operation providing state, the image forming device is configured not to cause the display to display the main body operation screen to disable an operation on the main body operation screen, and
in a case where the image forming device is not in the first remote operation providing state, the image forming device is configured to cause the display to display the main body operation screen.

19. The image forming device according to claim 8,
the image forming device is configured to change the content of the main body operation screen in a case where an event as a trigger for changing the main body operation screen occurs in a state where the image forming device is not in the first remote operation providing state,
in a case where the image forming device enters the first remote operation providing state, the image forming device is configured not to change the content of the main body operation screen to disable an operation on the main body operation screen in a case where an event as a trigger for changing the main body operation screen occurs, and
in a case where the image forming device is not in the first remote operation providing state, the image forming device is configured to change the content of the main body operation screen in the case where the event as a trigger for changing the main body operation screen occurs.
